(19) United States
(12) Patent Application Publication
(10) Pub. No.: US 2016/0165219 A1
(43) Pub. Date: Jun. 9, 2016

(54) IMAGE DISPLAY DEVICE COMPRISING CONTROL CIRCUIT

(71) Applicant: Panasonic Intellectual Property Management Co., Ltd., Osaka (JP)

(72) Inventors: TAKEYOSHI TOKUHARA, Osaka (JP); SEIJI NISHIWAKI, Hyogo (JP); TSUGUHIRO KORENAGA, Osaka (JP); YOSHIO SHIMBO, Osaka (JP)

(21) Appl. No.: 14/955,084

(22) Filed: Dec. 1, 2015

(30) Foreign Application Priority Data
Dec. 8, 2014 (JP) 2014-248346
Mar. 25, 2015 (JP) 2015-062910
Jun. 4, 2015 (JP) 2015-113905

(51) Int. Cl. H04N 13/04

(52) U.S. Cl. CPC H04N 13/0404; H04N 13/0497

(57) ABSTRACT

An image display device according to an aspect of the present disclosure includes: a display including light-emitting elements arrayed two-dimensionally, and having regions, in each of which a part of the light-emitting elements is located; a lens array including lenses, each of the lenses being disposed correspondingly to one of the regions, the lens array forming real images or virtual images of images displayed at each of the regions; and a control circuit that, in operation, controls each of the light-emitting elements, the control circuit being electrically connected to the display, and, in operation, causing a first part of the light-emitting elements to emit light when the control circuit causes a second part of the light-emitting elements different from the first part of the light-emitting elements not to emit light.

### BACKGROUND

1. Technical Field

The present disclosure relates to an image display device.

2. Description of the Related Art

Humans are capable of three-dimensionally perceiving images by (1) focal adjustment of the crystalline lens of the eye, (2) disparity of the eyes (difference in what is seen by the right eye and the left eye), (3) convergence of the eyes, and other like sensory perceptions. Generally displays used with gaming devices, televisions, and so forth, have a two-dimensional display face. The user can be made to three-dimensionally perceive images displayed on this display face (two-dimensional images) by using the effects of the above (1) through (3). Particularly, displays using the effects of the above (2) and (3) are commercially available. For example, Japanese Unexamined Patent Application Publication No. 8-194273 discloses a configuration using the effects of the above (2) and (3) by way of lenticular lenses.

FIG. 19 is a diagram schematically illustrating a three-dimensional image display device disclosed in Japanese Unexamined Patent Application Publication No. 8-194273. A two-dimensional light emitter 21 such as a liquid crystal display or the like is made up of a great number of pixels 21P. Each pixel 21P is divided into two regions; a region 21R and a region 21L. Lenticular lenses 20 are arrayed on the surface of the light emitter 21, corresponding one-on-one to the pixels 21P.

Due to the light condensing effects of the lenticular lenses 20, light generated in the regions 21R of the pixels 21P forms an image at a condensing point 4R, and light generated in the regions 21L forms an image at a condensing point 4L. The regions 21R and regions 21L each display different images, taking disparity into consideration. By placing a human right eye and left eye at the respective condensing point 4R and condensing point 4L, the images are perceived as a three-dimensional image due to the effects of (2) and (3) described above. That is to say, the right eye only senses the image displayed at the regions 21R, and the left eye only senses the image displayed at the regions 21L. Disparity information (disparity of the two eyes) has been added to these two images. The lines of sight intersect by both the right eye and left eye being fixed on the surface of the light emitter 21 (convergence of the eyes).

### SUMMARY

In one general aspect, the techniques disclosed here feature an image display device that includes: a display including light-emitting elements arrayed two-dimensionally, and having regions, in each of which a part of the light-emitting elements is located; a lens array including lenses, each of the lenses being disposed correspondingly to one of the regions, the lens array forming real images or virtual images of images displayed at each of the regions; and a control circuit that, in operation, controls each of the light-emitting elements, the control circuit being electrically connected to the display, and, in operation, causing a first part of the light-emitting elements to emit light when the control circuit causes a second part of the light-emitting elements different from the first part of the light-emitting elements not to emit light.

In an image display device according to an aspect of the present disclosure, an image can be displayed by time-division, so a high-definition image can be displayed. Also, the image can be perceived by the focal points of the crystalline lenses of the eyes being adjusted, so the optical load on the user is small.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional diagram schematically illustrating the positional relationship of a display member, lenses, control circuit, and displayed image, and optical paths, in an image display device according to a first embodiment;

FIG. 2 is a three-dimensional representation schematically illustrating the positional relationship of the display member, lenses, control circuit, and displayed image, in the first embodiment;

FIG. 3 is a cross-sectional diagram schematically illustrating the positional relationship between light-emitting elements of the display member, and pixels in the displayed image, in the first embodiment;

FIG. 4A is a diagram illustrating an example of a control method of the control circuit according to the first embodiment, along a time axis;

FIG. 4B is a diagram illustrating an example of a control method of the control circuit according to the first embodiment, along a time axis;

FIG. 5 is a three-dimensional representation schematically illustrating a modification of the first embodiment;

FIG. 6 is a cross-sectional diagram illustrating optical paths in a modification of the first embodiment that uses a mirror lens and beam splitter;

FIG. 7 is a three-dimensional representation schematically illustrating the positional relationship of the display member, beam splitter, mirror lens, and displayed image, in a modification of the first embodiment;

FIG. 8A is a diagram illustrating another modification of the first embodiment;

FIG. 8B is a plane view illustrating the configuration of an electronic shutter in the first embodiment;

FIG. 9A is a cross-sectional view illustrating the configuration of an image display device according to a second embodiment;

FIG. 9B is a diagram schematically illustrating the positional relationship of a display member, lenses, shielding member, and displayed image, and optical paths, in an image display device according to the second embodiment;

FIG. 10A is a diagram illustrating an example of a shielding member;

FIG. 10B is a diagram illustrating an example of the cross-sectional structure of the shielding member;

FIG. 10C is a diagram illustrating an example of the cross-sectional structure of a shielding member having undulations;

FIG. 10D is an upper view illustrating an example of a resist pattern for forming the undulations;

FIG. 10E is a cross-sectional view illustrating an example of a resist pattern for forming the undulations;

FIG. 10F is a cross-sectional view illustrating another example of a resist pattern for forming the undulations;

FIG. 10G is a diagram illustrating another example of a shielding member;

FIG. 11 is a diagram for describing reflection properties at the surface of the shielding member;

FIG. 12 is a cross-sectional view schematically illustrating the structure of an image display device according to a third embodiment, the positional relationship of a display member, lenses, shielding member, and displayed image, and optical paths;

FIG. 13 is a three-dimensional representation schematically illustrating the positional relationship of the display member, lenses, shielding member, and displayed image, in the third embodiment;

FIG. 14A is a diagram schematically illustrating the positional relationship of a display member, lenses, two polarizer arrays, and displayed image, in a fourth embodiment;

FIG. 14B is a plan view illustrating the configuration of the two polarizer arrays in the fourth embodiment;

FIG. 15A is a diagram schematically illustrating the positional relationship of a display member, lenses, electronic shutter, and displayed image, in a fifth embodiment;

FIG. 15B is a diagram for describing an example of control in the fifth embodiment;

FIG. 16A is a diagram for describing a first modification of the fifth embodiment;

FIG. 16B is a diagram for describing a second modification of the fifth embodiment;

FIG. 17A is a diagram illustrating a first state in the second modification of the fifth embodiment;

FIG. 17B is a diagram illustrating a second state in the second modification of the fifth embodiment;

FIG. 17C is a diagram illustrating a third state in the second modification of the fifth embodiment;

FIG. 17D is a diagram illustrating a fourth state in the second modification of the fifth embodiment;

FIG. 18A is a diagram illustrating a first state in a third modification of the fifth embodiment;

FIG. 18B is a diagram illustrating a second state in the third modification of the fifth embodiment;

FIG. 18C is a diagram illustrating a third state in the third modification of the fifth embodiment;

FIG. 18D is a diagram illustrating a fourth state in the third modification of the fifth embodiment;

FIG. 19 is a diagram illustrating the structure and optical paths of a conventional three-dimensional image display device;

FIG. 20 is a cross-sectional view schematically illustrating the positional relationship of a display member, lenses, and displayed image, and optical paths, in a three-dimensional image display device according to a study case;

FIG. 21 is a three-dimensional representation schematically illustrating the positional relationship of a display member, lenses, and displayed image, in a first study case;

FIG. 22 is a diagram for describing a layout of pixel elements in an original image;

FIG. 23A is a diagram illustrating the positional relationship of the center of an image displayed in a divided region, the center of a lens, and the center of a displayed image, in a study case;

FIG. 23B is a diagram illustrating the positional relationship of the center of the image displayed in a divided region, the center of the lens, and the center of the displayed image, in the study case, as viewed along the z axis from the positive side of the z axis;

FIG. 24A is a diagram illustrating the positional relationship of the center of an image displayed in a divided region, the center of a lens, and the center of a displayed image, in a modification of the study case;

FIG. 24B is a diagram illustrating the positional relationship of the center of the image displayed in a divided region, the center of the lens, and the center of the displayed image, in the modification of the study case, as viewed along the z axis from the positive side of the z axis;

FIG. 24C is a diagram illustrating the positional relationship of the center of the image displayed in a divided region, the center of the lens, and the center of the displayed image, in another modification of the study case, as viewed along the z axis from the positive side of the z axis;

FIG. 25 is a three-dimensional representation schematically illustrating the positional relationship of a display member, lenses, and displayed image, in a second study case;

FIG. 26A is a diagram illustrating luminance distribution of pixel images in displayed images according to the first and second study cases;

FIG. 26B is a diagram exemplarily illustrating overlapping of luminance distribution of pixel images in displayed images according to the first and second study cases;

FIG. 27 is a cross-sectional diagram schematically illustrating the structure of a three-dimensional image display device according to a third study case, and the positional relationship of a display member, lenses, and displayed image, and optical paths; and

FIG. 28 is a three-dimensional representation schematically illustrating the positional relationship of a display member, lenses, and displayed image, in the third study case.

### DETAILED DESCRIPTION

Prior to describing embodiments of the present disclosure, study cases will be described, in which the conventional art has been improved and studied. According to the three-dimensional image display device in Japanese Unexamined Patent Application Publication No. 8-194273, the eyes of the user are focused on the surface of the light emitter 21 (focal point). On the other hand, the intersection of the lines of sight is situated at the position of the three-dimensional image, and accordingly is deviated from the surface of the light emitter 21. This means that in principle, the position of the focal point where the crystalline lenses of the eyes is adjusted, and the position of intersection of parallax of the eyes do not match. Accordingly, the viewing of the image is unnatural to the user, so the optical load on the user is great. The present inventors studied a configuration where multiple lenses are used to form virtual images at different positions (study cases), as improvements on the conventional examples. These study cases will be described below with reference to the drawings. Note that in the following description, components which are the same or equivalent will be denoted by the same reference numerals.

### First Study Case

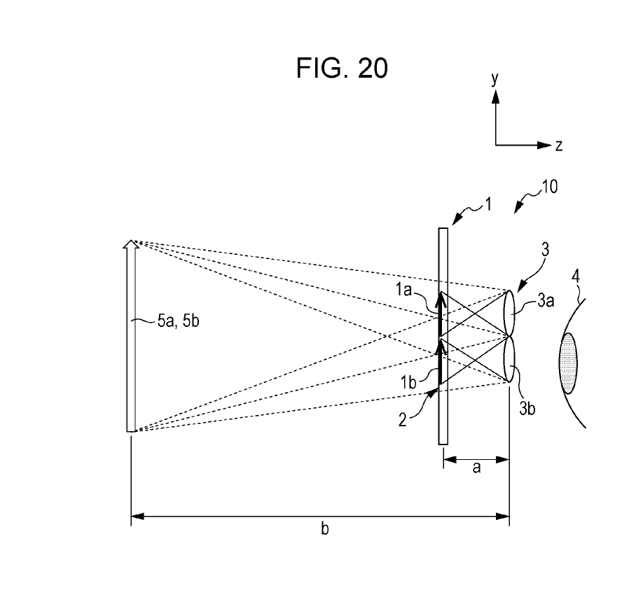

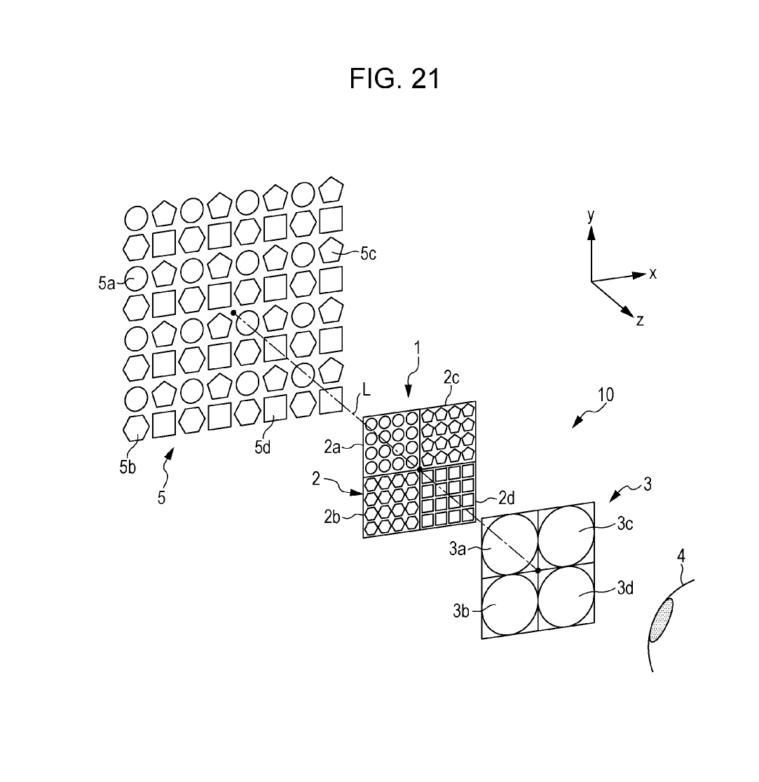

FIGS. 20 and 21 are diagrams schematically illustrating the configuration of an image display device 10 in a study case. The image display device 10 has a display member 1 and a lens array 3. The lens array 3 illustrated in FIGS. 20 and 21 has four lenses 3a through 3d, as one example, but this is not restrictive, and the number of lenses included in the lens array 3 may be any number of two or more. In the attached drawings, an x-y plane is a plane parallel to the display face of the display member 1. The positive direction in the y-axis direction corresponds to the upper direction of the display member 1 and the image display device 10. The z axis is orthogonal to the x-y plane, and the z-axis direction corresponds to the depth direction of the display member 1, i.e., to the front-back direction of the image display device 10. The positive direction in the z-axis direction corresponds to the front of the image display device 10 (the direction from the display member 1 toward a user 4).

The display member 1 is, for example, a display such as a liquid crystal display, organic electroluminescent (EL) display, or the like. The display member 1 has multiple light-emitting elements (represented by circles, hexagons, pentagons, and squares) arrayed two-dimensionally on the display face, as illustrated in FIG. 21. In the present study case, eight light-emitting elements are arrayed in the x direction, and eight in the y direction, for a total of 64 light-emitting elements. The arrayed 64 light-emitting elements make up a basic region 2 (a set of four divided regions 2a, 2b, 2c, and 2d). The basic region 2 is part or all of the display face of the display member 1 where images are displayed. In a case where the basic region 2 is part of the display face, multiple regions that are the same as the basic region 2 are arrayed in the x direction and y direction, making up a single display face. Accordingly, display images corresponding to large screens can be formed. The light-emitting elements may be the smallest increment of the displayed image, such as a pixel or color pixel of the display member 1, or the like. Alternatively, a set of multiple pixels or color pixels of the same shape may be handled as a single light-emitting element.

The basic region 2 made up of multiple light-emitting elements arrayed two-dimensionally is divided into the multiple divided regions 2a, 2b, 2c, and 2d. Each divided region includes multiple light-emitting elements. Neither the number of divided regions included in the basic region 2, nor the number of light-emitting elements included in each divided region, are restricted in particular. In the present study case, each divided region includes four light-emitting elements in the x direction and four in the y direction, for a total of 16 light-emitting elements. Each of the four divided regions 2a through 2d individually display images 1a through 1d by multiple light-emitting elements emitting light. FIG. 20 illustrates the images 1a and 1b of the images 1a through 1d. The images 1c and 1d are also formed to the right side of the images 1a and 1b when viewed from the user 4.

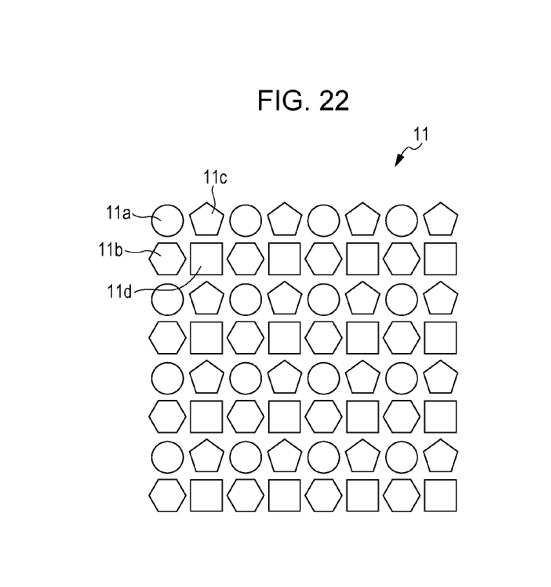

FIG. 22 illustrates an original image 11 of an image displayed on the display member 1. The original image 11 has eight pixel elements that are arrayed in the x direction, and eight in the y direction, for a total of 64 pixel elements. Note that pixels 11a (indicated by circles) are situated every other pixel in both the x direction and the y direction. In the same way, pixels 11b (indicated by hexagons), pixels 11c (indicated by pentagons), and pixels 11d (indicated by squares), are each situated every other pixel. The image made up of the group of pixels 11a is compacted and displayed by the light-emitting elements in the divided region 2a. The image made up of the group of pixels 11b is compacted and displayed by the light-emitting elements in the divided region 2b. The image made up of the group of pixels 11c is compacted and displayed by the light-emitting elements in the divided region 2c. The image made up of the group of pixels 11d is compacted and displayed by the light-emitting elements in the divided region 2d.

The lens array 3 is disposed in close proximity to the surface of the display member 1. The lens array 3 includes individual lenses 3a, 3b, 3c, and 3d, disposed correspondingly to the divided regions 2a through 2d. Now, the expression here that one divided region and one lens “correspond” means that much of a light flux emitted from that divided region (e.g., half or more), enters that lens. For example, in a case where one divided region and one lens are disposed facing each other, the two can be said to be corresponding. In a case where the path of a light beam changes by an optical system, such as a mirror, beam splitter, or the like being placed between the divided region and the lens, the divided region and the lens are not facing each other. However, even in such a case, the two are corresponding if much of a light flux emitted from that divided region enters that lens.

The focal distance (f) is the same for all of the lenses 3a through 3d. An expression of f>a holds, where “a” represents the distance between each of the lenses 3a through 3d and the display member 1. Accordingly, the lenses 3a through 3d form the images 1a through 1d each displayed at the divided regions 2a through 2d as virtual images. The positions of the lenses 3a through 3d are adjusted so that the virtual images of the images 1a through 1d overlap. The virtual images of the images 1a through 1d overlap and form a display image 5. The display image 5 is made up of display images 5a through 5d. The display images 5a through 5d are each virtual images of the images 1a through 1d. The pixel virtual images making up each of the display images 5a through 5d (respectively represented by circles, hexagons, pentagons, and squares, in FIG. 21) are arrayed at every other pixel on the image plane. The pixel virtual images are arrayed so as to fill in gaps between each other. Overall, the array of the display image 5 is the same as that of the pixels of the original image 11.

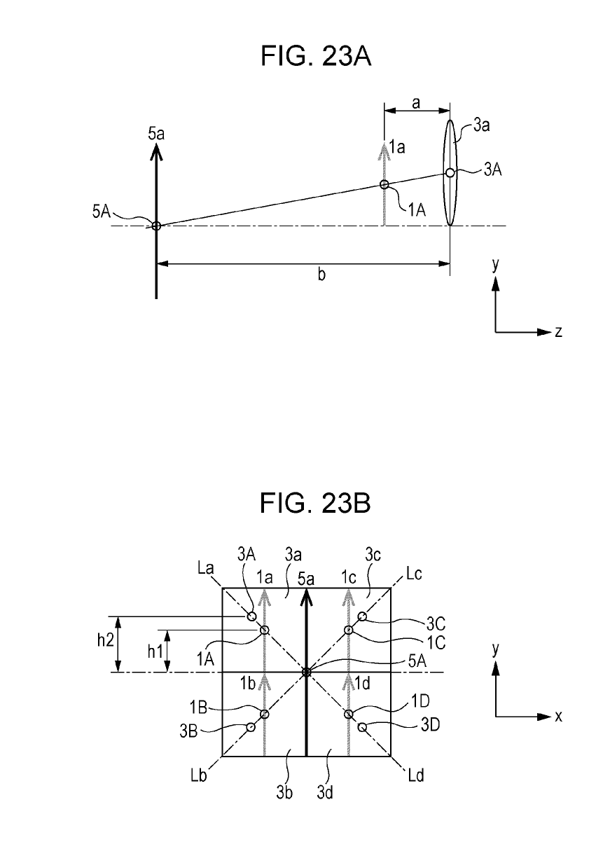

Now, the relationship between the center position of the image displayed in one divided region, and the center position of a lens, will be described with reference to FIGS. 23A and 23B. FIG. 23A schematically represents the positional relationship between the lens 3a, the image 1a displayed on the divided region 2a corresponding thereto, and the display image 5a, as one example. Here, “a” represents the distance between the lens 3a and the image 1a, and “b” represents the distance between the lens 3a and the display image 5a. According to the lens formula, the center 1A of the image 1a, the center 3A of the lens 3a, and the center 5A of the display image 5a, are on a straight line. In the same way, the center 1B of the image 1b, the center 3B of the lens 3b, and the center 5B of the display image 5b (i.e., 5A), are on a straight line. The center 1C of the image 1c, the center 3C of the lens 3c, and the center 5C of the display image 5c (i.e., 5A), are on a straight line, and the center 1D of the image 1d, the center 3D of the lens 3d, and the center 5D of the display image 5d (i.e., 5A), are on a straight line.

FIG. 23B schematically illustrates the positional relationship of the centers 1A through 1D of the images 1a through 1d, the centers 3A through 3D of the lenses 3a through 3d, and the centers 5A through 5D of the display images 5a through 5d, as viewed along the z axis (optical axis) from the positive side of the z axis. When viewing the image 1a, lens 3a, and display image 5a along the z axis, the center 3A of the lens 3a, the center 1A of the image 1a, and the center 5A of the display image 5a, are disposed arrayed on a straight line La. In the same way, when viewing the image 1b, lens 3b, and display image 5b along the z axis, the center 3B of the lens 3b, the center 1B of the image 1b, and the center 5B of the display image 5b (i.e., 5A), are disposed arrayed on a straight line Lb. When viewing the image 1c, lens 3c, and display image 5c along the z axis, the center 3C of the lens 3c, the center 1C of the image 1c, and the center 5C of the display image 5c (i.e., 5A), are disposed arrayed on a straight line Lc, and when viewing the image 1d, lens 3d, and display image 5d along the z axis, the center 3D of the lens 3d, the center 1D of the image 1d, and the center 5D of the display image 5d (i.e., 5A), are disposed arrayed on a straight line Ld.

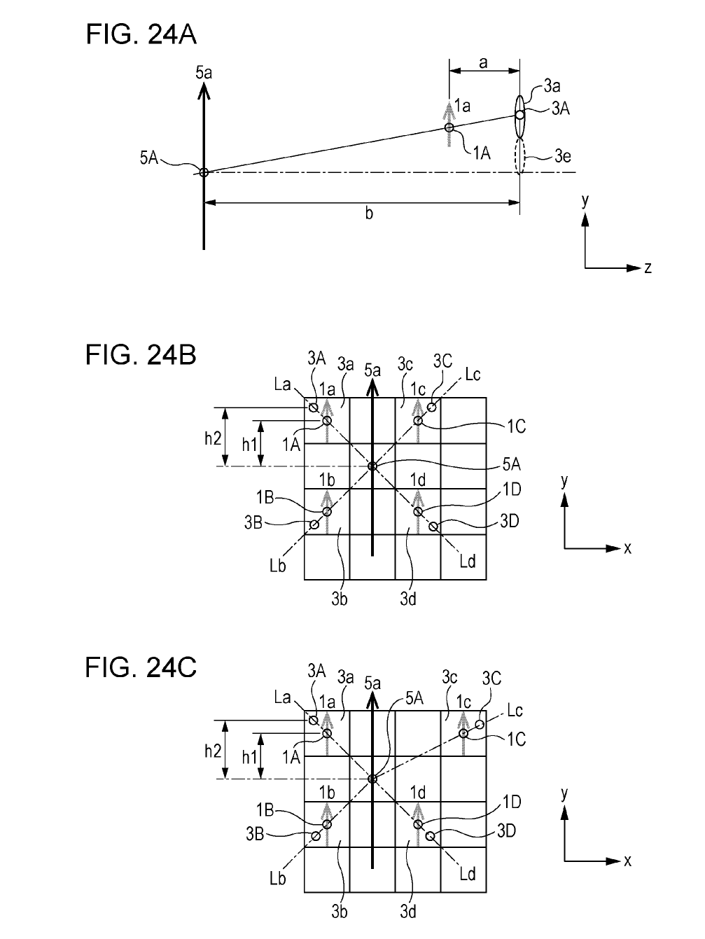

Note that the lenses 3a through 3d do not necessarily have to be adjacent. FIGS. 24A and 24B are diagrams illustrating a configuration example where a separate lens 3e is interposed between the lenses 3a through 3d. In this configuration example, of the 16 divided regions arrayed in four rows and four columns, the divided regions of the first row and first column, the first row and third column, the third row and first column, and the third row and third column, correspond to the divided regions 2a, 2b, 2c, and 2d, respectively. Other multiple lenses having focal distances the same as or different from the lenses 3a through 3d are provided over the other divided regions. In a case where other multiple lenses having focal distances the same as the lenses 3a through 3d are provided, an arrangement may be made where those lenses and the lenses 3a through 3d complementary form a single display image. FIG. 24C illustrates another example of an array of multiple divided regions and multiple lenses. In the example in FIG. 24C, lenses 3a and 3c are disposed two apart in the x direction, and lenses 3b and 3d are disposed one apart in the x direction. The intervals at which the lenses 3a through 3d are disposed do not have to be constant. In the example in FIGS. 24B and 24C, there may be divided regions existing regarding which no corresponding lens is provided.

In this case as well, the center 1A (or 1B, 1C, 1D) of the image 1a (or 1b, 1c, 1d), the center 3A (or 3B, 3C, 3D) of the lens 3a (or 3b, 3c, 3d), and the center 5A (where 5A=5B=5C=5D) of the display image 5a (or 5b, 5c, 5d), are on a straight line, as illustrated in FIG. 24A. Also, when viewing along the z axis from the positive direction, the center 3A (or 3B, 3C, 3D) of the lens 3a (or 3b, 3c, 3d), the center 1A (or 1B, 1C, 1D) of the image 1a (or 1b, 1c, 1d), and the center 5A (where 5A=5B=5C=5D) of the display image 5a (or 5b, 5c, 5d), are disposed arrayed on a straight line La (or Lb, Lc, Ld).

The following Expression (1)

h1/h2=(b−a)/b Expression (1)

holds where h2 represents the distance in the y axis direction between the center 3A of the lens 3a and the center 5A of the display image 5a, and h1 represents the distance between the center 1A of the lens 1a and the center 5A of the display image 5a. The same holds for the image 1b, image 1c, and image 1d, as well.

Moving the lenses or display member in the x, y, and z directions according to Expression (1) to move the center of the lenses and the center of the images displayed in the divided regions enables the positions of the display images to be freely adjusted. Accordingly, images displayed at multiple divided regions can be formed overlaid on the same image plane, thereby enabling the display image 5 of the same pixel array as the original image 11 illustrated in FIG. 22 to be formed.

The display images 5a, 5b, 5c, and 5d formed as described above are images actually formed at the position as seen from the eyes of the user 4. The present study case enables the sizes of each of the lenses 3a through 3d to be reduced as compared with the conventional configuration where a display image visually recognized by the user is formed from an image displayed on the display face, using a single lens. Accordingly, the focal distance of each lens can be reduced, and so the device can be made smaller and thinner.

### Second Study Case

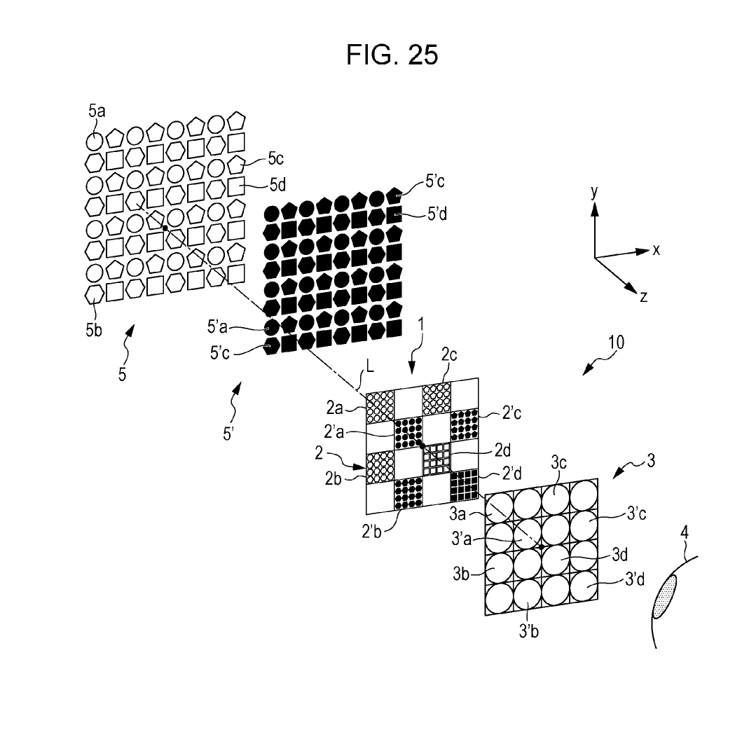

Next, another study case will be described. FIG. 25 is a diagram illustrating a configuration example in a case where, of the 16 divided regions arrayed in four rows and four columns, lenses 3a through 3d having a focal distance fa, and lenses 3′a through 3′d having a focal distance fd that is different from fa, are arrayed. The focal distances of the lenses 3a through 3d and 3′a through 3′d are shorter than the focal distances of conventional configurations, as mentioned above. Expressions fa>a and fb>a hold regarding the focal distances fa and fb, where “a” represents the distance between each of the lenses 3a through 3d and 3′a through 3′d, and the display member 1. The lenses 3a through 3d form the images 1a through 1d displayed at the respectively corresponding divided regions 2a through 2d as a virtual image 5, at a position from the lenses 3a through 3d by a distance ba determined by the following Expression (2) in the -z direction. The lenses 3′a through 3′d form images 1′a through 1′d displayed at respectively corresponding divided regions 2′a through 2′d as a virtual image 5′, at a position from the lenses 3′a through 3′d by a distance bb determined by the following Expression (3) in the -z direction.

ba=fa×a/(fa−a) Expression (2)

bb=fb×a/(fb−a) Expression (3)

Since fb differs from fa, the positions at which the display images 5 and 5′ are formed also differ in the thickness direction L (z direction) of the display member 1. That is to say, the eyes of the user 4 are focused (focal point) at the positions of the display images 5 and 5′, and thus the image display device 10 can cause the user 4 to perceive multiple display images with different distance perceptions. Accordingly, a usage is conceivable where the display image 5 formed at a distance relatively far from the eyes of the user 4 is relegated displaying of a background image, while the display image 5′ formed at a distance relatively near to the eyes of the user 4 is relegated displaying an object image such as a person or the like.

Note that the combination of lenses 3a through 3d and lenses 3′a through 3′d in this example is but one example of combining lenses with different focal distances. The lens array 3 may be divided into three or more lens groups each having different focal distances. Arrangements regarding the combinations and arrays of multiple lenses having the same focal distance within each lens group are not restricted to the above-described examples, either.

The image display device 10 such as described above may be disposed correspondingly to either one or both of the right eye and left eye of the user 4. In a case where two image display devices 10 are disposed correspondingly to the two eyes of the user 4, different images regarding which disparity of the right and left eyes has been taken into consideration are displayed on the display members 1 of the image display devices 10. Thus, the user 4 can perceive stereoscopic images.

The first and second study cases satisfy the condition of (1) focal adjustment of the crystalline lens of the eye when viewing with one eye, and further satisfy the conditions of (2) disparity of the eyes and (3) convergence of the eyes when viewing with both eyes. Accordingly, the image appears natural, since the difference in distance is perceived through focal adjustment by the crystalline lens of the eye. When viewing with both eyes, the position of focusing and the position where the lines of sight of the eyes intersect agree, so the optical load on the user 4 is small. While the first and second study cases have been described by way of a lens array that diffracts light, this may be realized instead by an array of multiple mirror lenses which are disposed correspondingly to the multiple divided regions, and respectively reflect light from the multiple divided regions to form a virtual image.

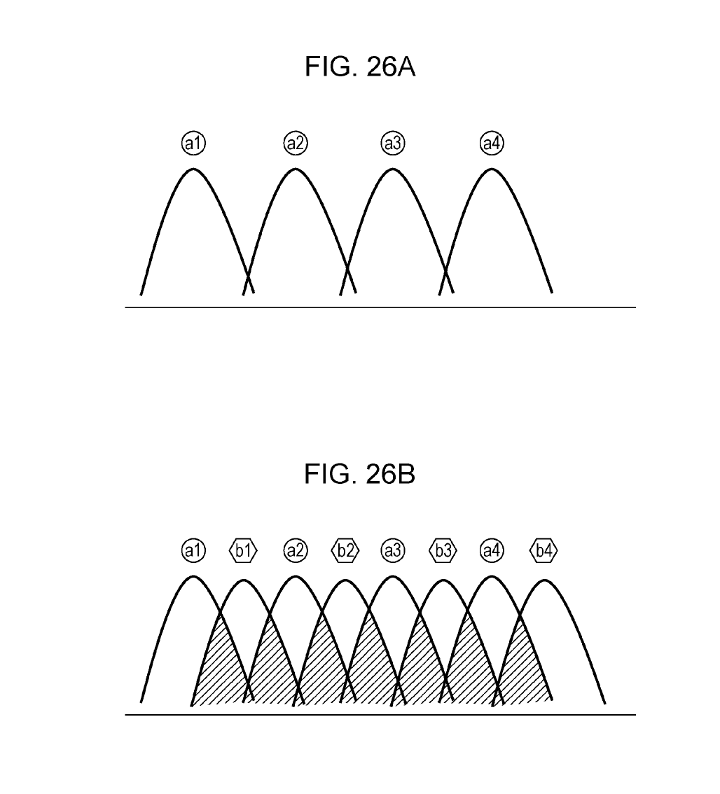

Although the first and second study cases where the related art has been improved have been described, these study cases are problematic in that the original image 11 cannot be displayed with high definition. This will be described by way of FIGS. 26A and 26B.

FIG. 26A illustrates an example of luminance distribution of a1 through a4, which are part of a pixel image making up a display image 5a. The form of the luminance distribution is decided by the properties of the display member 1 and lens array 3 that are used. The luminance distribution of display images 5a through 5d is approximately the same as the distribution in FIG. 26A at a certain portion. The display images 5a and 5b are arrayed so as to fill in between the pixel virtual images of each other. Accordingly, the luminance distribution is such as illustrated in FIG. 26B with both the display images 5a and 5b are displayed at the same time. The display images 5a and 5b have a region where the luminance distributions of each others pixel images overlap. If the display images 5a and 5b have luminance values that are close to each other, the luminance is high at the middle of the overlapped regions. In such a case, the original peaks of the pixel virtual images a1 through a4 become indiscernible, and accordingly, the definition of the original image 11 appears to be lower.

### Third Study Case

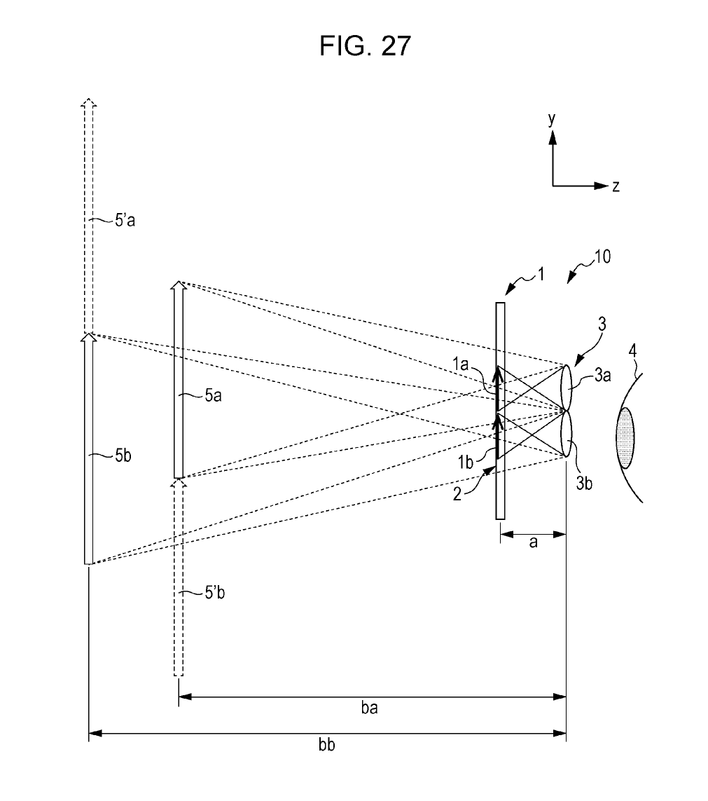

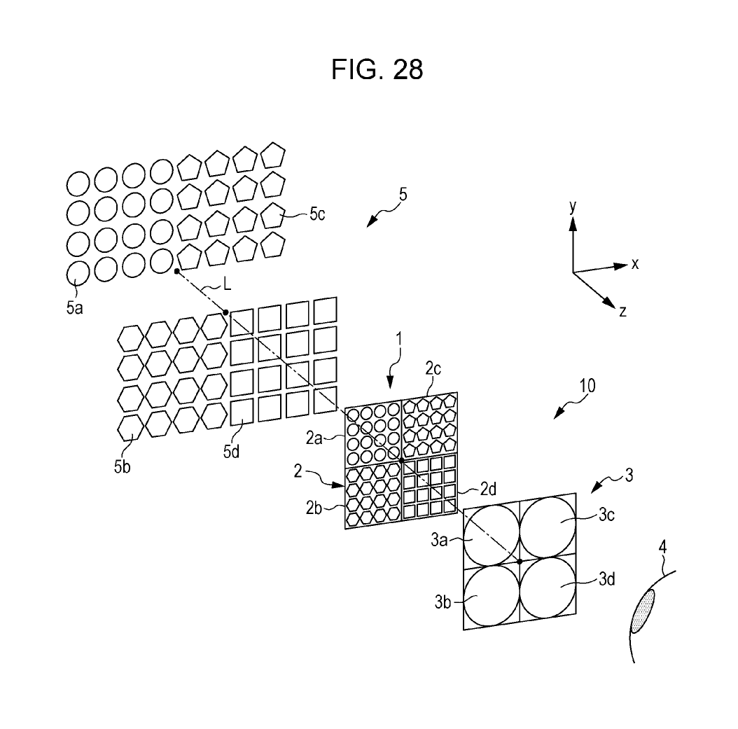

FIGS. 27 and 28 are diagrams schematically illustrating the configuration of a image display device 10 according to a third study case. This image display device 10 has a display member 1 and a lens array 3. Although the lens array 3 illustrated in FIGS. 27 and 28 has four lenses 3a and 3d as one example, it is sufficient for the number of lenses included in the lens array 3 to be two or more.

The focal distances of the lenses 3a through 3d differ from each other. The focal distances of the lenses 3a, 3b, 3c, and 3d are, respectively, fa, fb, fc, and fd. Expressions fa>a, fb>a, fc>a, and fd>a, hold regarding the focal distances, where “a” represents the distance between each of the lenses 3a through 3d and the display member 1. The lens 3a forms the image 1a displayed at the corresponding divided region 2a as a virtual image 5a, at a position from the lens 3a by a distance ba determined by the following Expression (4) in the -z direction. The lens 3b forms the image 1b displayed at the corresponding divided region 2b as a virtual image 5b, at a position from the lens 3b by a distance bb determined by the following Expression (5) in the -z direction. The lens 3c forms the image 1c displayed at the corresponding divided region 2c as a virtual image 5c, at a position from the lens 3c by a distance be determined by the following Expression (6) in the -z direction. The lens 3d forms the image 1d displayed at the corresponding divided region 2d as a virtual image 5d, at a position from the lens 3d by a distance bd determined by the following Expression (7) in the -z direction.

ba=fa×a/(fa−a) Expression (4)

bb=fb×a/(fb−a) Expression (5)

be=fc×a/(fc−a) Expression (6)

bd=fd×a/(fd−a) Expression (7)

Note that FIG. 28 illustrates the display images 5a and 5c, and the display images 5b and 5d, aligned regarding display position in the z direction. Part or all of the display images may be aligned regarding display position in the z direction as illustrated in this example. In a case where the focal distances fa through fd differ for the lenses 3a through 3d, the positions where the display images 5a through 5d are formed will also differ in the thickness direction L (z direction) of the display member 1 for each divided region. As a result, the user 4 can be caused to perceive multiple display images with different distance perceptions. Accordingly, a usage is conceivable where the display image formed at a distance relatively far from the eyes of the user is relegated displaying of a background image, while the display image formed at a distance relatively near to the eyes of the user 4 is relegated displaying of an object image such as a person or the like, for example.

The display images 5a through 5d are not arrayed so as to fill in the gaps between each others pixel virtual images, so the problem described by way of FIGS. 26A and 26B does not readily occur in this study case. However, from the position of the user 4, an image can also be seen through each lens that does not belong to the divided region corresponding to that lens but to a divided region adjacent to the divided region corresponding to that lens. For example, looking through the lens 3b, not only the image 1b of the divided region 2b but also the image 1a of the adjacent divided region 2a can also be seen. That is to say, the user 4 not only sees multiple display images with difference distance perceptions (images 5a and 5b in the example in FIG. 27) but also unnecessary images (images 5a′ and 5b′ in the example in FIG. 27) adjacent to these images. The unnecessary image 5a′ is a virtual image corresponding to the image 1a on the divided region 2a which can be seen through the lens 3b. The unnecessary image 5b′ is a virtual image corresponding to the image 1b on the divided region 2b which can be seen through the lens 3a. In other words, crosstalk occurs among divided regions in the configuration according to the third study case.

The present inventors have reached a new configuration that solves at least one of the problems in the first through third study cases, and enables display of images with higher definition. The present disclosure includes image display devices according to the following Items.

### Item 1

An image display device includes: a display including light-emitting elements arrayed two-dimensionally, and having regions, in each of which a part of the light-emitting elements is located; a lens array including lenses, each of the lenses being disposed correspondingly to one of the regions, the lens array forming real images or virtual images of images displayed at each of the regions; and a control circuit, that, in operation controls each of the light-emitting elements, the control circuit being electrically connected to the display, and, in operation, causing a first part of the light-emitting elements to emit light when the control circuit causes a second part of the light-emitting elements different from the first part of the light-emitting elements not to emit light.

### Item 2

The image display device according to Item 1, wherein the real images or virtual images of the images are formed to interpolate each other.

### Item 3

The image display device according to either Item 1 or 2, wherein: the first part of the light-emitting elements and the second part of the light-emitting elements are located next to each other.

### Item 4

The image display device according to either Item 1 or 2, wherein the first part of the light-emitting elements is located in one of the regions, and the second part of the light-emitting elements is located in another one of the regions.

### Item 5

The image display device according to Item 4 further includes: an electronic shutter array including electronic shutters disposed between the lens array and the display, each of the electronic shutters corresponding to one of the regions, wherein: the control circuit is electrically connected to the electronic shutter array and, in operation, controls a light transmission property of each of the electronic shutters; and synchronously with a timing of causing the first part of the light-emitting elements to emit light, the control circuit controls the light transmission property of a first part of the electronic shutters corresponding to the first part of the light-emitting elements to be a transmitting state, and controls the light transmission property of a second part of the electronic shutters corresponding to the second part of the light-emitting elements to be a shielding state.

### Item 6

The image display device according to any one of Items 1 through 5 further includes: a beam splitter, wherein the lens array is a mirror lens array that reflects light from the regions and forms the virtual images, and wherein the beam splitter is disposed between the display and the mirror lens array, the beam splitter transmitting a part of the light in a direction of the mirror lens array. The beam splitter may reflect a part of reflected light from the mirror lens array in a direction of an observing eye of a user.

### Item 7

An image display device includes: a display including light-emitting elements arrayed two-dimensionally, and having regions, in each of which a part of the light-emitting elements is located; a lens array including lenses, each of the lenses being disposed correspondingly to one of the regions, the lens array forming real images or virtual images of images displayed at each of the regions; an electronic shutter array including electronic shutters disposed between the lens array and the display, each of the electronic shutters disposed correspondingly to one of the regions; and a control circuit that is electrically connected to the light-emitting elements and the electronic shutter array and, in operation, controls a light-emitting state of each of the light-emitting elements and a light transmission property of each of the electronic shutters, wherein, synchronously with a timing of causing one of the images to be displayed at a first region of the regions by controlling the light-emitting state of the light-emitting elements, the control circuit controls a first electronic shutter of the electronic shutters that corresponds to the first region to be a transmitting state, and controls a second electronic shutter of the electronic shutters adjacent to the first electronic shutter to be a shielding state.

### Item 8

The image display device according to Item 7, wherein, when displaying the one of the images at the first region, the control circuit displays the one of the images in a manner extending into second region adjacent to the first region as well.

### Item 9

The image display device according to Item 7, wherein an optical distance between each of the lenses and the corresponding one of the regions differs from a focal distance of each of the lenses.

### Item 10

An image display device includes: a display including light-emitting elements; a lens array including lenses disposed on paths of optical fluxes from a display face of the display, each of the lenses being disposed correspondingly to one of divided regions included in the display face, an optical distance between the lenses and the divided regions being different from a focal distance of the lenses; electronic shutters disposed between the display and the lens array, each of the electronic shutters being disposed correspondingly to one of the divided regions; and a control circuit that is electrically connected to the light-emitting elements and the electronic shutters, and, in operation, controls a light emission state of the light-emitting elements and a transmission property of the electronic shutters, wherein, synchronously with a timing of causing image to be displayed at a first divide region of the divided regions, the control circuit controls a first electronic shutter of the electronic shutters that corresponds to the first divided region to a transmitting state, and controls a second electronic shutter of the electronic shutters adjacent to the first electronic shutter to a shielding state.

### Item 11

The image display device according to Item 10, wherein, when displaying the image at the first divided region, the control circuit displays the image in a manner extending into a second divided region adjacent to the first divided region as well.

### Item 12

An image display device includes: a display including light-emitting elements arrayed two-dimensionally, and having a display face configured by an array of the light-emitting elements being divided into divided regions; a lens array including lenses, each of the lenses being disposed correspondingly to one of the divided regions, the lens array forming real images or virtual images from images displayed at each of the divided regions; and a light-shielding partition disposed between the lens array and the light-emitting elements, and disposed on paths of light rays from the divided regions that head toward lenses to which the divided regions do not correspond.

### Item 13

The image display device according to Item 12, wherein the light-shielding partition has undulations having faces inclined as to a plane perpendicular to the display face.

### Item 14

The image display device according to Item 13, wherein half or more of an area of the light-shielding partition is covered by the inclined faces.

### Item 15

The image display device according to either Item 13 or 14, wherein the undulations have structures of stripes extending substantially parallel to the display face.

### Item 16

An image display device includes: a display including light-emitting elements arrayed two-dimensionally, and having a display face configured by the array of the light-emitting elements being divided into divided regions; a lens array including lenses, each of the lenses being disposed correspondingly to one of the divided regions, the lens array forming real images or virtual images from images displayed at each of the divided regions; a first polarizer array disposed between the display and the lens array, having first linear polarizers, each of which is disposed correspondingly to one of the divided regions, polarization directions of two adjacent first linear polarizers of the first linear polarizers being orthogonal to each other; and a second polarizer array disposed between the first polarizer array and the lens array, having second linear polarizers, each of which is disposed correspondingly to one of the divided regions, polarization directions of two adjacent second linear polarizers of the second linear polarizers being orthogonal to each other; wherein the polarization direction of one of the first linear polarizers and the polarization direction of one of the second linear polarizers corresponding to the same divided region of the divided regions are substantially the same.

### Item 17

An image display device includes: a display; a lens array including lenses disposed on paths of optical fluxes emitted from a display face of the display, each of the lenses being disposed correspondingly to one of divided regions included in the display face, an optical distance between the lenses and the divided regions being different from a focal distance of the lenses; and a light-shielding partition disposed on paths of light rays from the divided regions that head toward lenses to which the divided regions do not correspond.

### Item 18

An image display device includes: a display; a lens array including lenses disposed on paths of optical fluxes emitted from a display face of the display, each of the lenses being disposed correspondingly to one of divided regions included in the display face, an optical distance between the lenses and the divided regions being different from a focal distance of the lenses; a first polarizer array disposed between the display and the lens array, having first linear polarizers, each of which is disposed correspondingly to one of the divided regions, polarization directions of two adjacent first linear polarizers of the first linear polarizers being orthogonal to each other; and a second polarizer array disposed between the first polarizer array and the lens array, having second linear polarizers, each of which is disposed correspondingly to one of the divided regions, polarization directions of two adjacent second linear polarizers of the second linear polarizers being orthogonal to each other; wherein the polarization direction of one of the first linear polarizers and the polarization direction of one of the second linear polarizers corresponding to the same divided region are substantially the same.

### First Embodiment

Embodiments of the present disclosure will be described below with reference to the drawings. Note that in the following description, components which are the same or equivalent will be denoted by the same reference numerals. The following description only relates to an example of the present disclosure, and the present disclosure is not restricted thereby.

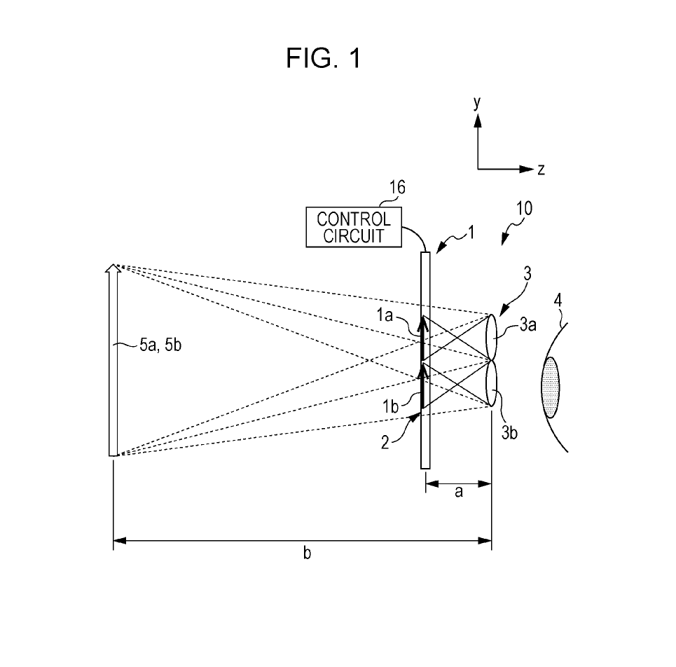

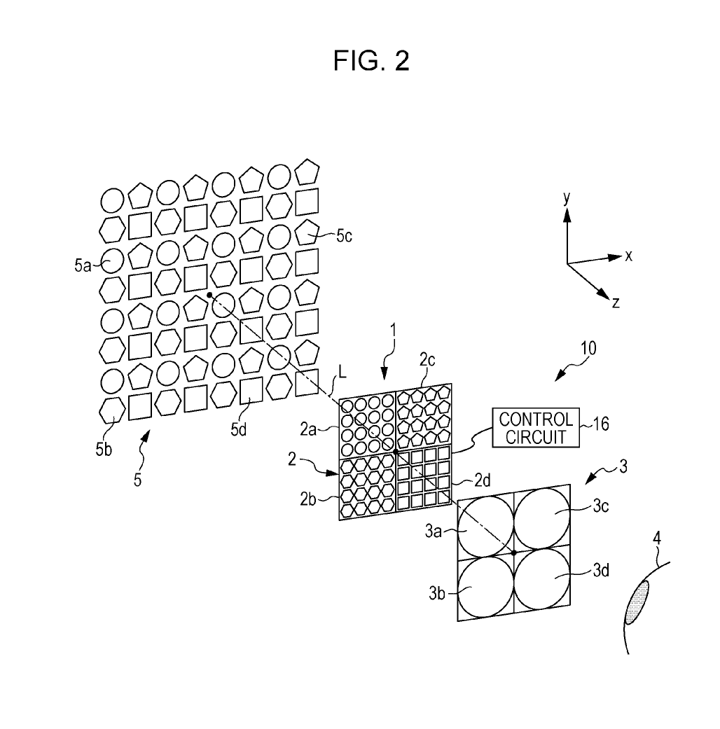

FIGS. 1 and 2 are diagrams schematically illustrating the image display device 10 according to a first embodiment. This image display device 10 includes a display member 1, a control circuit 16, and a lens array 3. The present embodiment differs from the first study example in that the image display device 10 has the control circuit 16 to control the light-emitting states of each of multiple light-emitting elements. Providing the control circuit 16 enables deterioration in image quality of the display image to be suppressed. Other than this point, the configuration of the present embodiment is the same as that of the study cases. Accordingly, description of repetitive content may be omitted hereinafter.

The display member 1 is, for example, a transmissive liquid crystal display, a reflective liquid crystal display, an organic electroluminescence (EL) display, or the like. The display member 1 has multiple light-emitting elements (represented by circles, hexagons, pentagons, and squares) arrayed two-dimensionally on the display face, as illustrated in FIG. 2. In the present embodiment, eight light-emitting elements are arrayed in the x direction, and eight in the y direction, for a total of 64 light-emitting elements. The arrayed 64 light-emitting elements make up a basic region 2. The basic region 2 is part or all of the display face of the display member 1 where images are displayed. In a case where the basic region 2 is part of the display face, multiple regions that are the same as the basic region 2 are arrayed in the x direction and y direction, making up a single display face. Accordingly, display images corresponding to large screens can be formed. The light-emitting elements may be a pixel, a color pixel, or a set of pixels or color pixels of the same shape, of the display member 1.

The basic region 2 made up of multiple light-emitting elements arrayed two-dimensionally is divided into the multiple divided regions 2a, 2b, 2c, and 2d. Each divided region includes multiple light-emitting elements. Neither the number of divided regions included in the basic region 2, nor the number of light-emitting elements included in each divided region, are restricted in particular. In the present embodiment, each divided region includes four light-emitting elements in the x direction and four in the y direction, for a total of 16 light-emitting elements. Each of the four divided regions 2a through 2d individually display images 1a through 1d by light-emitting elements emitting light.

The lens array 3 is disposed in close proximity to the surface of the display member 1. The lens array 3 includes individual lenses 3a, 3b, 3c, and 3d, disposed correspondingly to the divided regions 2a through 2d. The focal distance (f) is the same for all of the lenses 3a through 3d. The relationship of f>a is satisfied, where “a” represents the distance between each of the lenses 3a through 3d and the display member 1. Accordingly, the lenses 3a through 3d form the images 1a through 1d each displayed at the divided regions 2a through 2d as virtual images. The positions of the lenses 3a through 3d are adjusted so that the virtual images of the images 1a through 1d overlap. Pixel virtual images making up each of the display images 5a through 5d (respectively represented by circles, hexagons, pentagons, and squares, in FIG. 21) are arrayed at every other pixel on the image plane. The pixel virtual images are arrayed so as to fill in gaps between each other. Overall, the array of the display image (virtual image) 5 is the same as that of the pixels of the original image 11 illustrated in FIG. 22.

Moving the lenses or display member in the x, y, and z directions according to Expression (1) to move the center of the lenses and the center of the images displayed in the divided regions enables the positions of the display images to be freely adjusted. Accordingly, images displayed at multiple divided regions can be formed overlaid on the same image plane, thereby enabling the display image 5 of the same pixel array as the original image 11 illustrated in FIG. 22 to be formed.

Next, the operations of the control circuit 16 will be described. The control circuit 16 is electrically connected to the display member 1 as illustrated in FIG. 2, and controls light emission of each of the multiple light-emitting elements. Objects of control by the control circuit 16 include single or multiple images formed by multiple light-emitting elements. A case of controlling light emission of multiple light-emitting elements making up divided images 1a, 1b, 1c, and 1d, respectively displayed on divided regions 2a, 2b, 2c, and 2d illustrated in FIG. 2, will be exemplarily described here.

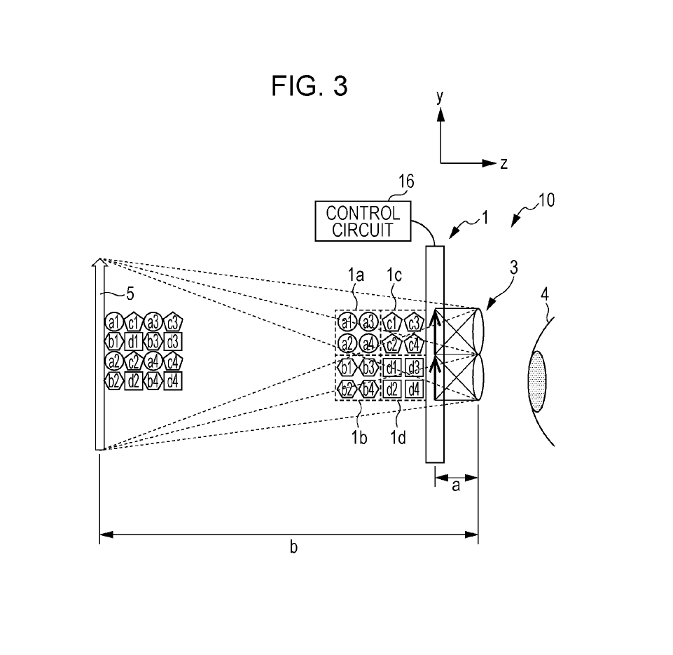

FIG. 3 illustrates a part of the multiple light-emitting elements making up the divided images 1a, 1b, 1c, and 1d. That is to say, the light-emitting elements a1 through a4 illustrated in FIG. 3 are part of the light-emitting elements making up the divided image 1a (shown as 2×2 light-emitting elements), and this is true for the others as well.

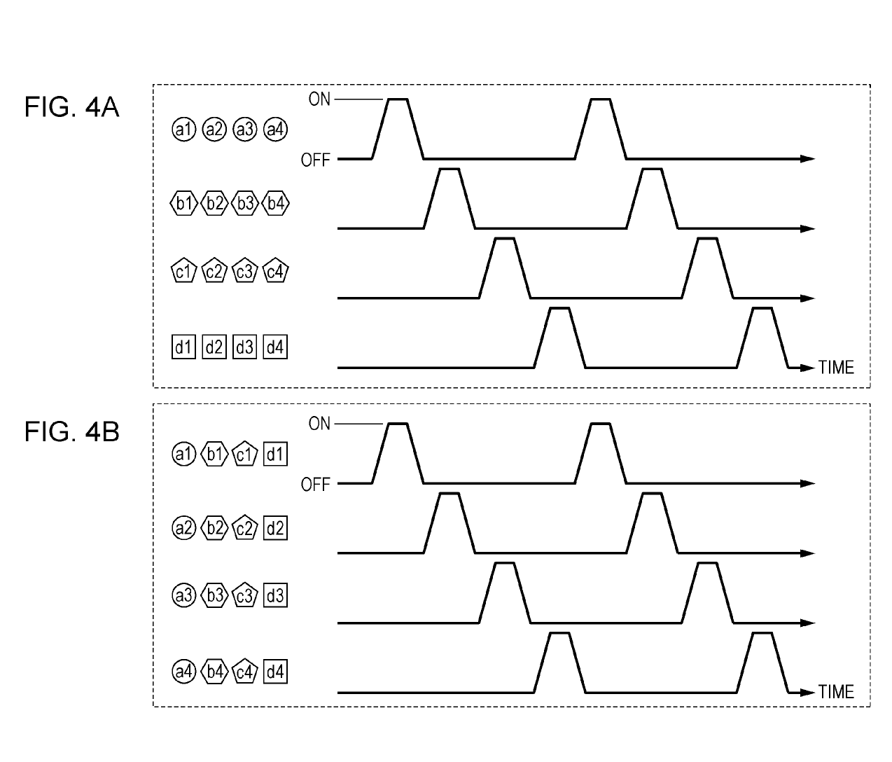

FIGS. 4A and 4B are exemplary diagrams schematically illustrating the timings at which the control circuit 16 displays the light-emitting elements al through a4, b1 through b4, c1 through c4, and d1 through d4, with time as an axis. FIG. 4A illustrates an example of a case where light-emitting elements a1 through a4 within the divided region 2a are lit at the same timing, this timing of lighting being different from the timings of the light-emitting elements b1 through b4, c1 through c4, and d1 through d4, of the other divided regions 2b through 2d. In the same way, the light-emitting elements b1 through b4 in the divided region 2b are lit at the same timing, and emit light at a timing different from the light-emitting elements in the other divided regions in this example. This is also true for the light-emitting elements c1 through c4 in the divided region 2c, and the light-emitting elements d1 through d4 in the divided region 2d. This includes cases of shifting the timing of display of the divided images 1a through 1d on the time axis, as well. In this example, the control circuit 16 causes the multiple light-emitting elements included in one divided region of the multiple divided regions, and multiple light-emitting elements included in another divided region, to be displayed at different timings.

FIG. 4B illustrates an example of a case where light-emitting elements a1, b1, c1, and d1 at different divided regions are made to emit light at the same timing, which is a different timing from the other light-emitting elements a2 through a4, b2 through b4, c2 through c4, and d2 through d4, at positions adjacent thereto. For example, this may be used in a case where the light-emitting elements a1, a2, a3, and a4 are color pixels. Specifically, this may be used in a case where the light-emitting elements a1, a2, a3, and a4 are red, green, green, and blue pixels, respectively. This is also true for the light-emitting elements b1 through b4, c1 through c4, and d1 through d4. In this example, the control circuit 16 causes, of the multiple light-emitting elements included in one of the multiple divided regions, two light-emitting elements at adjacent positions to emit light at different timings.

Thus, displaying part of the multiple light-emitting elements at a timing different from another part of the light-emitting elements reduces overlapping of luminance distribution among the pixels. By performing such switching cyclically at high speed, the user 4 can see each of the divided images 1a through 1d projected in high definition, and at the same time, the user 4 perceives the divided images 1a through 1d to be composited and observed as the original image 11 (FIG. 22).

Note that the lens array 3 may include multiple lenses having different focal distances, as described in the second study case. Alternatively, the lens array 3 may include combinations of multiple lenses where the distance from the display member 1 to the principal face of each lens differs.

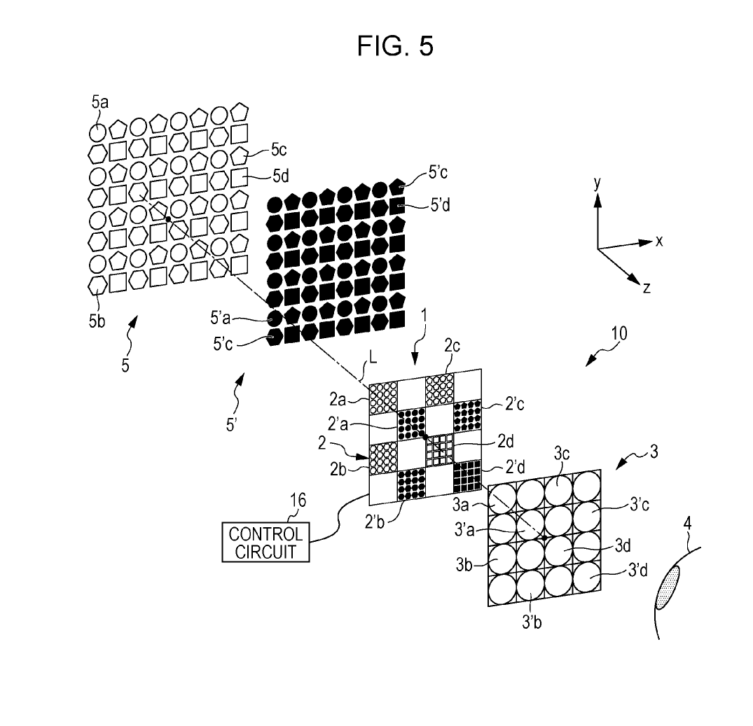

FIG. 5 is a diagram schematically illustrating the image display device 10 having a 4 x 4 lens array 3 corresponding to 4 x 4 divided regions, as in the second study case. In this example, the focal distance of the lenses 3a, 3b, 3c, and 3d is fa, and the focal distance of the lenses 3′a, 3′b, 3′c, and 3′d is fb which is different from fa (fa<fb). Lenses other than the lenses 3a through 3d and 3′a through 3′d have be different focal distances from fa and fb, or may be the same as one of fa and fb. Images displayed in divided regions other than the divided region 2a through 2d and 2′a through 2′d are omitted from illustration in FIG. 5.

According to this configuration, images 5a through 5d formed by the lenses 3a through 3d, and images 5′a through 5′d formed by the lenses 3′a through 3′d, are formed at different positions in the z direction. Thus, the image display device 10 can cause the user 4 to perceive multiple display images with different distance perceptions. Accordingly, a usage is conceivable where the display image 5 formed at a distance relatively far from the eyes of the user 4 is relegated displaying of a background image, while the display image 5′ formed at a distance relatively near to the eyes of the user 4 is relegated displaying an object image such as a person or the like, for example.

The image display device 10 such as described above may be disposed correspondingly to either one or both of the right eye and left eye of the user 4. In a case where two image display devices 10 are disposed correspondingly to the two eyes of the user 4, different images regarding which disparity of the right and left eyes has been taken into consideration are displayed on the display members 1 of the image display devices 10. Thus, the user 4 can perceive high-definition stereoscopic images.

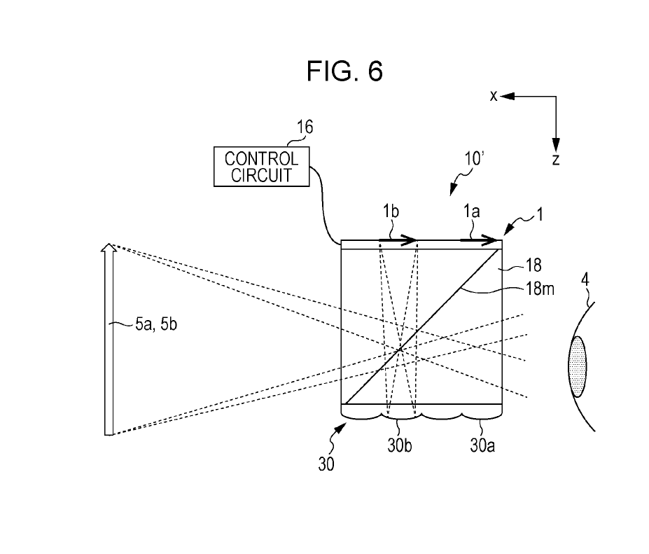

While the present embodiment has been described by way of a lens array 3 that diffracts light, this may be realized instead by an mirror lens array 30 instead of the lens array 3, as illustrated in FIG. 6. FIG. 6 is a diagram illustrating a configuration example of a image display device 10′ that has a mirror lens array 30. The image display device 10′ further has a beam splitter 18 (e.g., a half mirror) disposed between the display member 1 and the mirror lens array 30. Light emitted from the multiple light-emitting elements passes through a reflecting face 18m of the beam splitter 18 and is cast into the mirror lens array 30. The mirror lens array 30 is a set of multiple reflecting lenses (mirror lenses). A metal film is formed over the entire lens surface, acting as a reflecting face. Light input to this face is reflected, and is input to the reflecting face 18m again. The light component reflected at the reflecting face 18m here is visually recognized by the user 4.

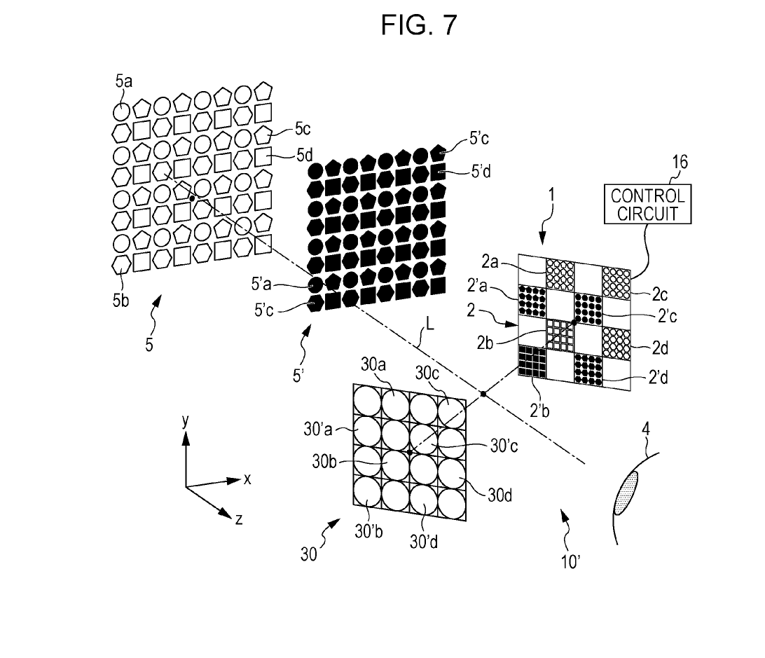

FIG. 7 is a diagram illustrating an example of an image formed in the present embodiment. By using the mirror lens array 30 in this example, the user 4 can be made to visually perceive the display image 5 and the display image 5′, in the same way as the case of using the lens array 3, as illustrated in FIG. 7. The control circuit 16 according to the present embodiment controls the multiple light-emitting elements facing the mirror lens array 30 via the beam splitter. An arrangement may also be made where the display image 5′ is not formed, as with the embodiment illustrated in FIG. 2.

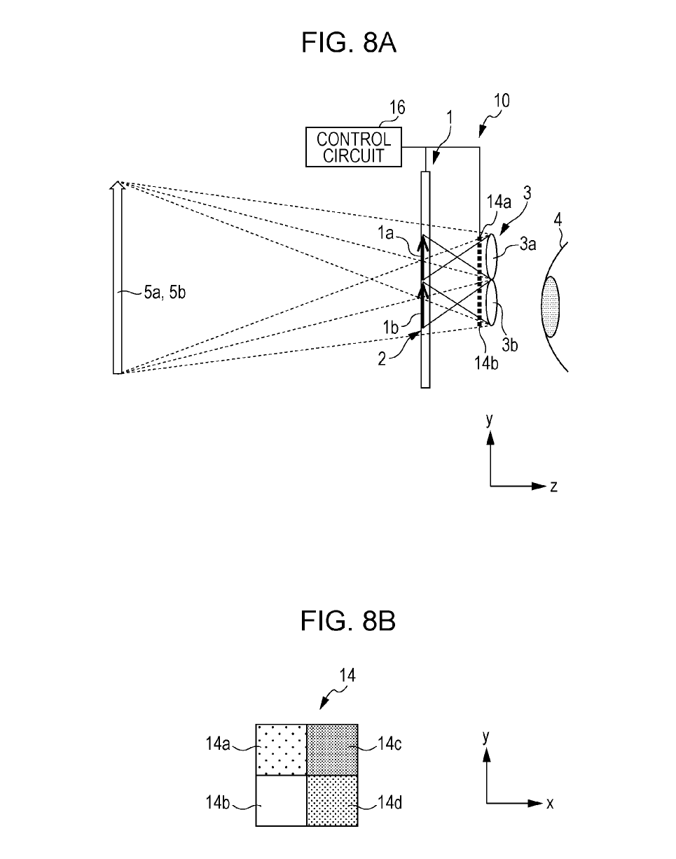

FIG. 8A is a diagram illustrating another modification of the present embodiment. The image display device 10 illustrated in FIG. 8A has multiple electronic shutter 14 disposed between the lens array 3 and the display member 1. FIG. 8B is a plan view illustrating the placement of the multiple electronic shutter 14 when viewed from the side of the user 4. The electronic shutters 14 in this example include four electronic shutters 14a through 14d. The electronic shutters 14a through 14d are disposed correspondingly to the divided regions 2a through 2d. Each electronic shutter is thus disposed correspondingly to one of the multiple divided regions.

The control circuit 16 is connected to the display member 1 and the multiple electronic shutters 14. The control circuit 16 can control the transmission properties (i.e., optical transmittance) of each of the multiple electronic shutters 14a through 14d. The phrase “transmitting state” means a state where the transmittance of light is relatively high, and the phrase “shielded state” means a state where the transmittance of light is relatively low. The transmitting state is not restricted to a state of 100% transmittance, and includes a transmittance that is somewhat high. In the same way, the shielded state is not restricted to a state of 0% transmittance, and includes a transmittance that is somewhat low.

The control circuit 16 in this example controls the emission state of the multiple light-emitting elements and the transmission properties of the multiple electronic shutters 14. The multiple light-emitting elements are lit at different timings for each divided region, in the same way as the control illustrated in FIG. 4A. Synchronously with the timing to display an image at one of the multiple divided regions, the control circuit 16 places the one of the multiple electronic shutters 14 corresponding to that divided region in a transmitting state, while placing the other electronic shutters adjacent to that electronic shutter in a shielded state. This control enables light fluxes passing through lenses other than the lens corresponding to the divided region emitting light to be shielded. This yields an advantage that crosstalk among divided regions can be suppressed.

The electronic shutter 14 can be fabricated by filling with liquid crystal a thin layer formed sandwiched between transparent electrodes between a pair of linear polarizers. The polarization direction of the transmitted light is rotated by applying the pair of transparent electrodes applying voltage to the liquid crystal sandwiched therebetween, thus enabling the transmitted light to be switched on (transmitting state) and off (shielded state). The multiple electronic shutters can be configured by patterning and dividing one of the transparent electrodes, and individually controlling voltage. In a case where the display member 1 is a light-emitting member of linearly polarized light such as a liquid crystal display, the linear polarizers at the display member side may be omitted.

### Second Embodiment

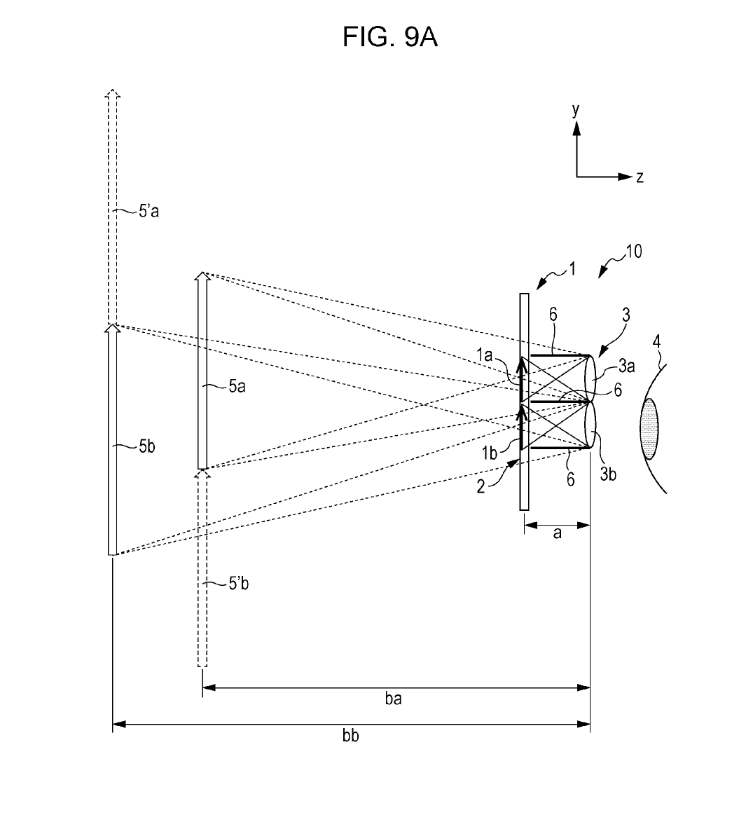

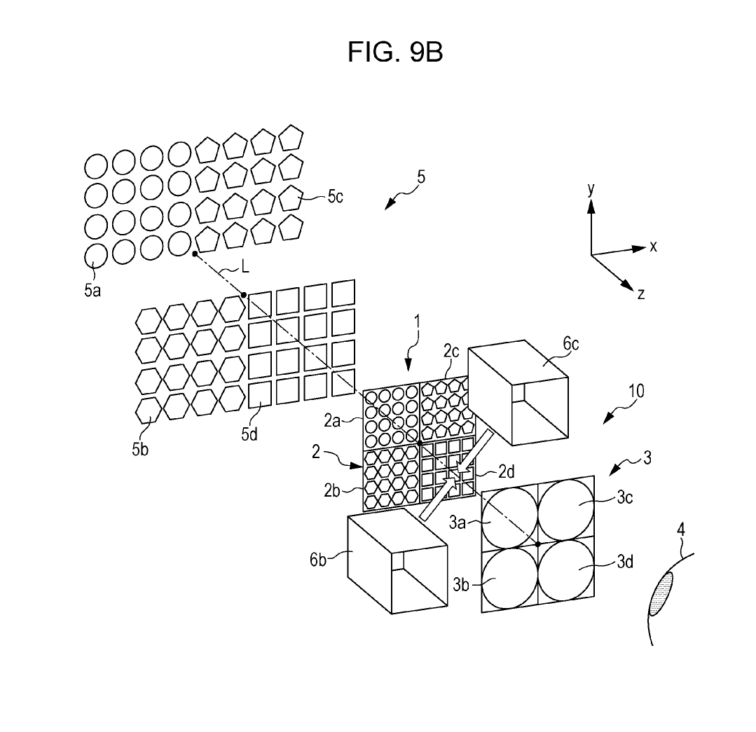

FIGS. 9A and 9B are diagrams schematically illustrating a image display device 10 according to a second embodiment. This image display device 10 includes the display member 1, a shielding member 6, and the lens array 3. The present embodiment differs from the third study case with regard to the point that the image display device 10 is provided with the shielding member 6 that has partitions with light shielding properties. Providing the shielding member 6 enables unnecessary light input to the lenses to be suppressed. Other than this point, the configuration of the second embodiment is the same as the configuration of the third study case. Accordingly, description of redundant content from the third study case may be omitted.

The display member 1 is, for example, a display such as a reflective liquid crystal display, an organic electroluminescence (EL) display, or the like. The display member 1 has multiple light-emitting elements (represented by circles, hexagons, pentagons, and squares) arrayed two-dimensionally on the display face, as illustrated in FIG. 9B. In the present embodiment, eight light-emitting elements are arrayed in the x direction, and eight in the y direction, for a total of 64 light-emitting elements. The 64 light-emitting elements make up a basic region 2. The basic region 2 is part or all of the display face of the display member 1 where images are displayed. In a case where the basic region 2 is part of the display face, multiple regions that are the same as the basic region 2 are arrayed in the x direction and y direction, making up a single display face. Accordingly, display images corresponding to large screens can be formed. The light-emitting elements may be a pixel, a color pixel, or a set of pixels or color pixels of the same shape, of the display member 1.

The basic region 2 made up of multiple light-emitting elements arrayed two-dimensionally is divided into the multiple divided regions 2a, 2b, 2c, and 2d. Each divided region includes multiple light-emitting elements. Neither the number of divided regions included in the basic region 2, nor the number of light-emitting elements included in each divided region, are restricted in particular. In the present embodiment, each divided region includes four light-emitting elements in the x direction and four in the y direction, for a total of 16 light-emitting elements. Each of the four divided regions 2a through 2d individually display images 1a through 1d by multiple light-emitting elements emitting light.

The lens array 3 is disposed in close proximity to the surface of the display member 1. The lens array 3 includes individual lenses 3a, 3b, 3c, and 3d, disposed correspondingly to the divided regions 2a through 2d. The focal distance differs for each of the lenses 3a through 3d. The focal distances of the lenses 3a, 3b, 3c, and 3d are, respectively, fa, fb, fc, and fd. The focal distances satisfy the relationships of fa>a, fb>a, fc>a, and fd>a, where “a” represents the distance between each of the lenses 3a through 3d and the display member 1. The lens 3a forms the image 1a displayed at the corresponding divided region 2a as a virtual image 5a, at a position from the lens 3a by a distance ba determined by the following Expression (4) in the -z direction. The lens 3b forms the image 1b displayed at the corresponding divided region 2b as a virtual image 5b, at a position from the lens 3b by a distance bb determined by the following Expression (5) in the -z direction. The lens 3c forms the image 1c displayed at the corresponding divided region 2c as a virtual image 5c, at a position from the lens 3c by a distance be determined by the following Expression (6) in the -z direction. The lens 3d forms the image 1d displayed at the corresponding divided region 2d as a virtual image 5d, at a position from the lens 3d by a distance bd determined by the following Expression (7) in the -z direction.

The lenses 3a through 3d form the display images 5a through 5d at positions that differ from each other. FIG. 9A illustrates the display images 5a and 5c, and the display images 5b and 5d, aligned regarding display position in the z direction. Part or all of the display images may thus be aligned regarding display position in the z direction as illustrated in this example. In a case where the focal distances fa through fd differ for the lenses 3a through 3d, the positions where the display images 5a through 5d are formed will also differ in the thickness direction L (z direction) of the display member 1 for each divided region. As a result, the image display device 10 can cause the user 4 to perceive multiple display images with different distance perceptions. Accordingly, a usage is conceivable where the display image formed at a distance relatively far from the eyes of the user 4 is relegated displaying of a background image, while the display image formed at a distance relatively near to the eyes of the user is relegated displaying of an object image such as a person or the like.

The image display device 10 such as described above may be disposed correspondingly to either one or both of the right eye and left eye of the user 4. In a case where two image display devices 10 are disposed correspondingly to the two eyes of the user 4, different images regarding which disparity of the right and left eyes has been taken into consideration are displayed on the display members 1 of the image display devices 10. Thus, the user 4 can perceive stereoscopic images.

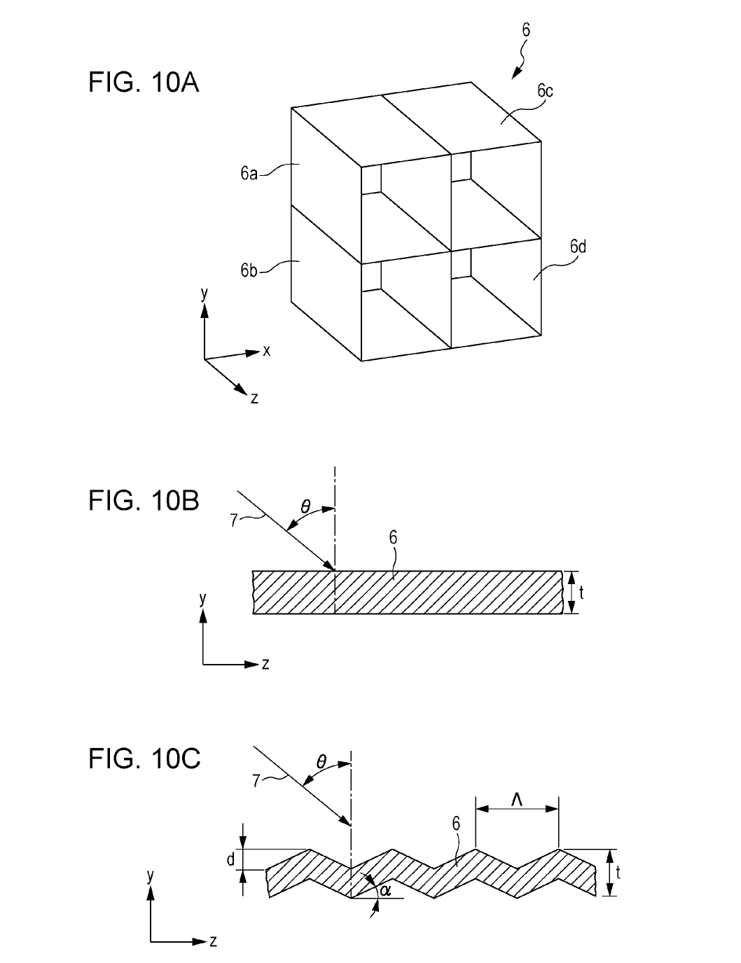

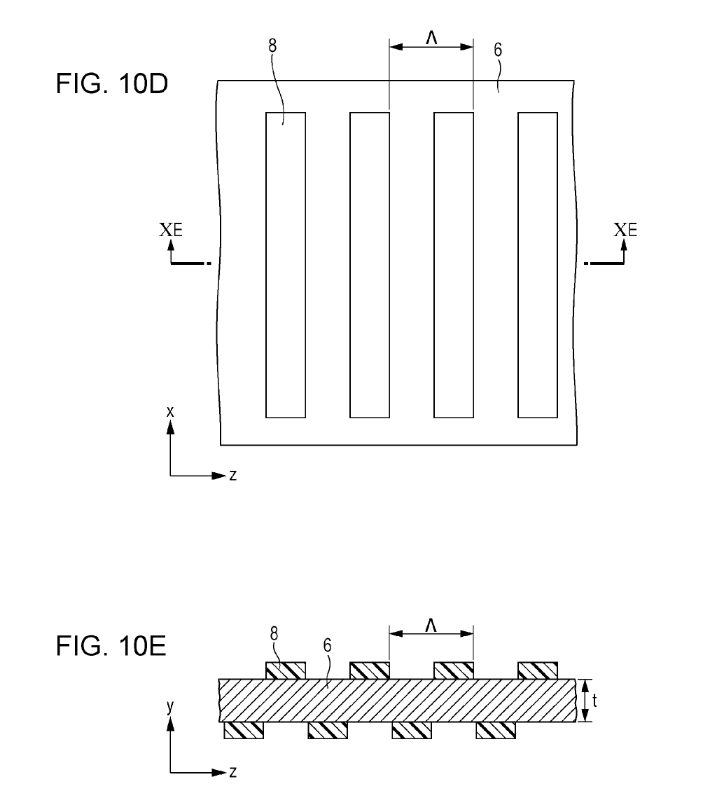

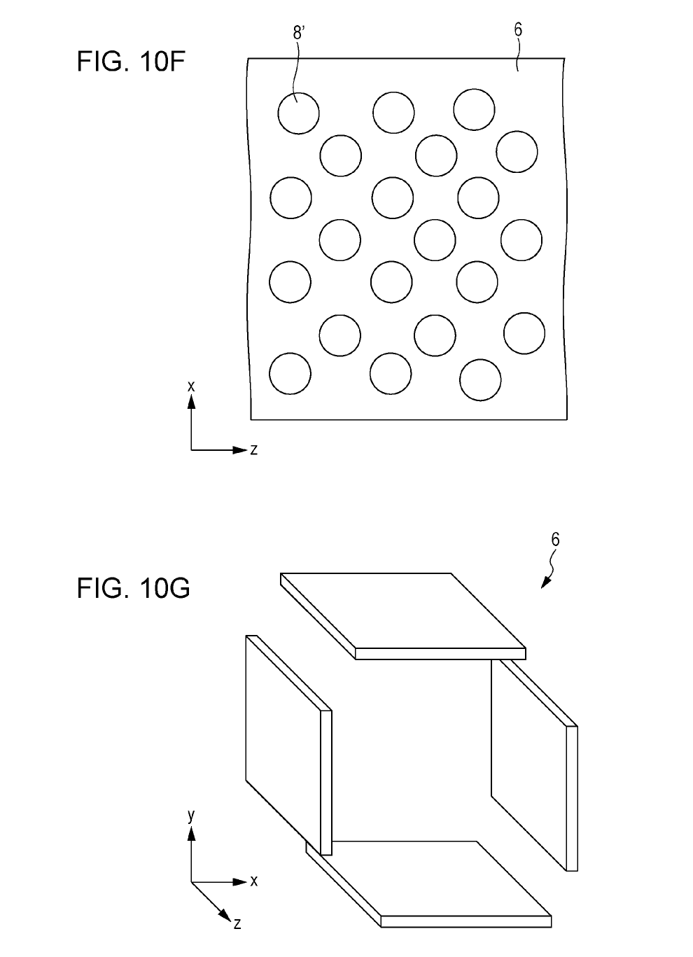

Next, the shielding member 6 according to the present embodiment will be described. FIG. 10A is a perspective view schematically illustrating the configuration of the shielding member 6. The shielding member 6 is interposed between the display member 1 and the lens array 3. The shielding member 6 includes individual shielding members 6a, 6b, 6c, and 6d disposed correspondingly to the respective divided regions 2a, 2b, 2c, and 2d. FIG. 9B only illustrates the shielding members 6b and 6c of these. The shielding members 6a through 6d are each tube-shaped, and neighboring shielding members are adjacent via the side walls of the tubes. These side walls function as light-shielding partitions. These partitions are situated on the optical paths of light rays from the multiple divided region that head toward lenses to which their divided regions do not correspond. The divided regions 2a through 2d are partitioned off from each other by these shielding members 6a through 6d. In other words, light generated at each divided region can be propagated to the corresponding lens, but propagation to adjacent lenses (lenses that do not correspond) is shielded. Accordingly, images to be displayed on adjacent divided regions are not seen through the lenses. Thus, unnecessary images adjacent to the display image are not visible as in the study case (images 5a′ and 5b′ in FIG. 27, for example).

FIG. 10B is a diagram illustrating a cross-section of the shielding member 6. A cross-section of a partition portion parallel to the x-z plane is illustrated as an example here. Other partition portions have the same structure. The shielding member 6 may be formed of a stainless steel plate having a thickness t of 0.1 mm, for example. The reflectance of the surface of the shielding member 6 is suppressed by processing such as black chromium plating or the like. However, this example is not restrictive, and it is sufficient for the shielding member 6 to be a light-shielding member.

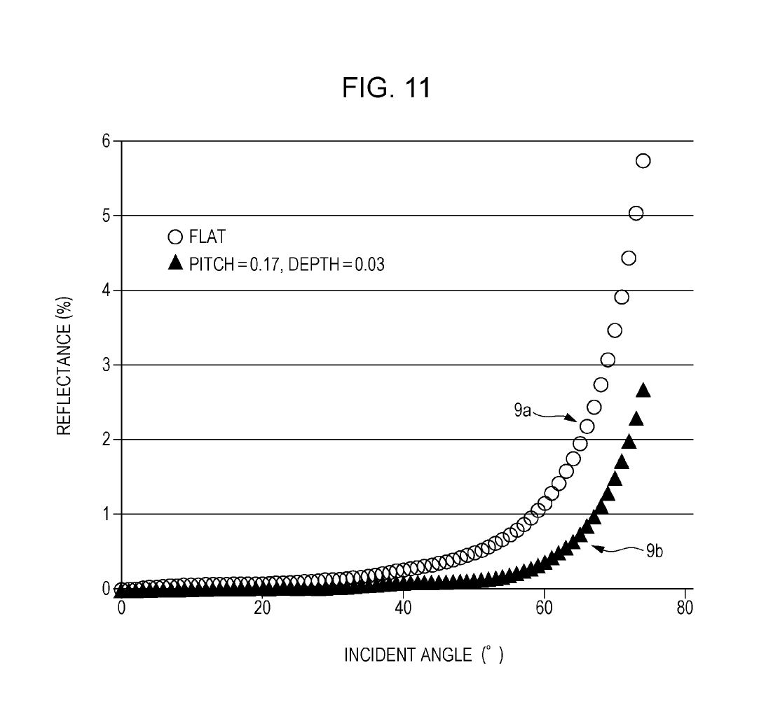

FIG. 11 is a diagram illustrating reflectance properties of the shielding member 6. A curve 9a represents actual measurement values of reflectance properties (the relationship of reflectance as to incident angle θ). The greater the incident angle θ is, the higher the reflectance is. The reflectance exceeds 1%, which is high, when the incident angle θ exceeds 60 degrees. Light emitted from the light-emitting element and entering the surface of the shielding member 6 includes components of which the incident angle θ exceeds 60 degrees as well. The aforementioned surface processing can increase the reflectance. This reflected light is also perceived as an unnecessary image in the eyes of the user 4.

This problem can be solved by forming undulations having faces inclined as to a face perpendicular to the display face (a face parallel to the z-x plane in the illustrated example) on the partitions of the shielding member 6. In one example, half or more of the surface area of the partition may be such inclined faces. Such undulations have structures of stripes extending generally parallel to the display face (x-y plane). In the example illustrated in FIG. 10C, each protruding portion (or each recessed portion) extends as a stripe in the x direction.

The undulated form such as illustrated in FIG. 10C can be fabricated by the following process, for example. FIG. 10D is a plan view illustrating a pattern of a resist 8 formed in the process of fabricating the undulations. FIG. 10E is a cross-sectional view taken along line XE-XE in FIG. 10D. First, the striped resist 8, having a pitch A is patterned on both sides of the stainless steel pate having the predetermined thickness t, as illustrated in FIGS. 10D and 10E. The direction of the stripes is generally parallel to the display face. The term “generally parallel” in the present specification is not restricted to strictly being parallel, and also includes arrangements in a range of angles from 0° to 15° between the two. In one embodiment, the thickness t may be set to 0.1 mm, and the pitch A to 0.17 mm. After the resist 8 is formed, both surfaces are subjected to etching to a depth d of 0.03 mm, for example. The article can thus be worked to the undulated cross-sectional appearance illustrated in FIG. 10C by side etching effects.

In a case where the cross-sectional form of the shielding member 6 has triangular inclinations with an inclination angle a, light with the incident angle θ is input to one side of the triangular inclinations at an angle of θ−α. In a case where θ is large and Γ>π/2−α, the other side of the triangular inclinations is shadowed from the incident light, and there is no incoming light. Accordingly, the reflectance properties are effectively shifted toward a smaller incident angle, due to the undulations. Consequently, the reflectance can be reduced.

The curve 9b illustrated in FIG. 11 represents the reflectance properties of the shielding member 6 after these undulations have been subjected to black chromium plating. It can be seen that the reflectance is reduced even in cases where the incident angle θ is great. According to this effect, occurrence of unwanted images due to reflection at the surface of the shielding member 6 can be suppressed.

Note that the pattern of the resist 8 may be other shapes as well. For example, a pattern that looks like checkers may be used, such as illustrated in FIG. 10F. The cross-sectional form of the undulations formed by etching is not restricted to triangular shapes; any shape will suffice as long as inclinations are formed.

While each of the individual shielding members 6a through 6d have been described in the present embodiment as having tubular structures, this structure is not restrictive. It is sufficient for each of the individual shielding members 6a through 6d to have partitions situated so as to shield at least part of light fluxes heading from one divided region to lenses to which the divided region does not correspond. For example, multiple plate-shaped shielding members may be provided that each pass through a boundary line between two adjacent divided regions and are separately provided from each other on planes perpendicular to the viewing face. FIG. 10G is a diagram illustrating a part of such a shielding member 6. In this example, four plate-shaped shielding members are provided instead of the shielding members 6a through 6d illustrated in FIG. 10A. This configuration also can shield at least part of unnecessary light fluxes, so the quality of the image perceived by the user 4 is improved.

### Third Embodiment

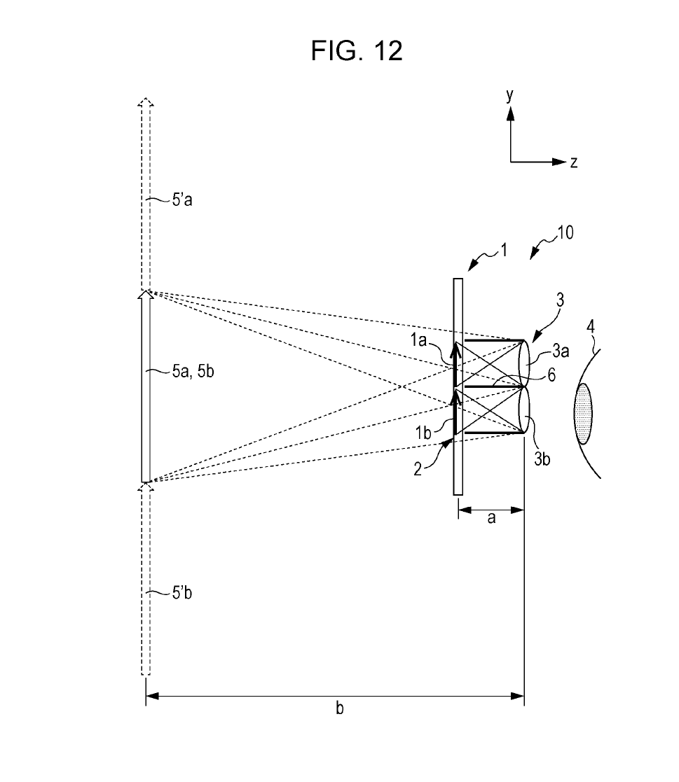

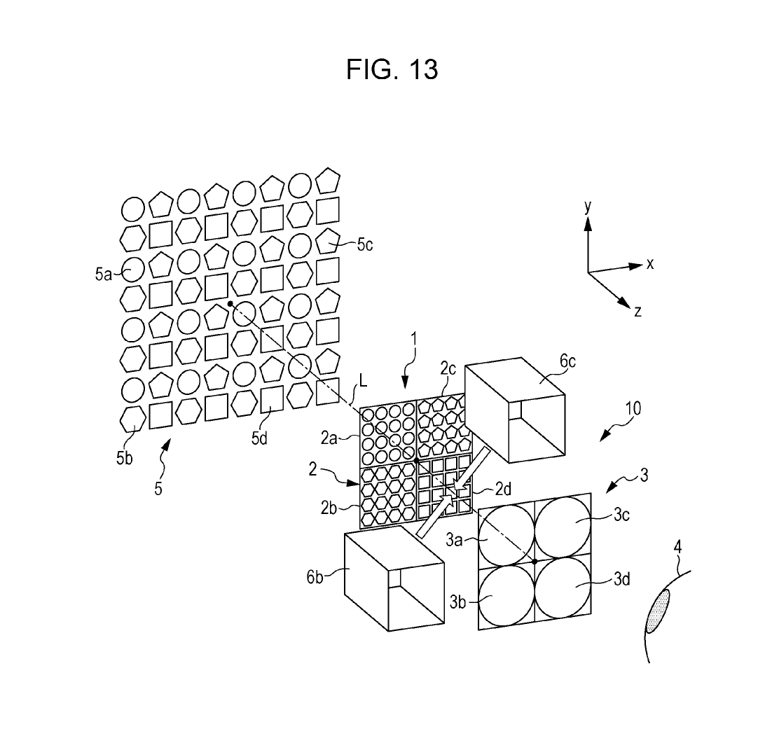

FIGS. 12 and 13 are diagrams schematically illustrating the image display device 10 according to a third embodiment. This image display device 10 includes the display member 1, shielding member 6, and lens array 3. The present embodiment differs from the second embodiment in that the image array method and the position of forming the virtual images formed by the lenses differ from the second embodiment, and the other configurations are the same. Accordingly, description of redundant content from the second embodiment may be omitted.

The image array method and the formation position of the virtual images formed by the lenses are the same as that in the first study case and the first embodiment, as illustrated in FIG. 13. The display member 1 has multiple light-emitting elements arrayed two-dimensionally on the display face. In the present embodiment, eight light-emitting elements are arrayed in the x direction, and eight in the y direction, for a total of 64 light-emitting elements. The 64 light-emitting elements make up a basic region 2. The light-emitting elements may be a pixel, a color pixel, or a set of pixels or color pixels of the same shape, of the display member 1.

The basic region 2 made up of multiple light-emitting elements arrayed two-dimensionally is divided into the multiple divided regions 2a, 2b, 2c, and 2d. Each divided region includes multiple light-emitting elements. Neither the number of divided regions included in the basic region 2, nor the number of light-emitting elements included in each divided region, are restricted in particular. In the present embodiment, each divided region includes four light-emitting elements in the x direction and four in the y direction, for a total of 16 light-emitting elements. Each of the divided regions 2a through 2d individually display images 1a through 1d by multiple light-emitting elements emitting light.

The lens array 3 is disposed in close proximity to the surface of the display member 1. The lens array 3 includes individual lenses 3a, 3b, 3c, and 3d, disposed correspondingly to the divided regions 2a through 2d. The focal distance (f) is the same for all of the lenses 3a through 3d. The relationship of f >a is satisfied, where “a” represents the distance between each of the lenses 3a through 3d and the display member 1. Accordingly, the lenses 3a through 3d form the images 1a through 1d on the divided regions 2a through 2d as virtual images. The positions of the lenses 3a through 3d are adjusted so that the virtual images of the images 1a through 1d overlap. Pixel virtual images making up each of the display images 5a through 5d (respectively represented by circles, hexagons, pentagons, and squares) are arrayed at every other pixel on the image plane. The pixel virtual images are arrayed so as to fill in gaps between each other. Overall, the array of the virtual image 5 is the same as that of the pixels of the original image 11 (FIG. 22).

The matter described with reference to FIGS. 22 through 24 applies as it is to the present embodiment as well. Accordingly, description thereof will be omitted.

The shielding member 6 is interposed between the display member 1 and the lens array 3, in the same way as in the second embodiment. The shielding member 6 includes individual shielding members 6a, 6b, 6c, and 6d disposed correspondingly to the respective divided regions 2a, 2b, 2c, and 2d. The shielding members 6a through 6d are each tube-shaped, and neighboring shielding members are adjacent via the side walls of the tubes. The divided regions 2a through 2d are partitioned off from each other by these shielding members 6a through 6d, so that light emitted at each divided region can be propagated to the corresponding lens, but propagation to adjacent lenses is shielded. Accordingly, images to be displayed on adjacent divided regions are not seen through the lenses. Thus, unnecessary images adjacent to the display image are not visible as in the study case (images 5a′ and 5b′ in FIG. 27, for example).

### Fourth Embodiment

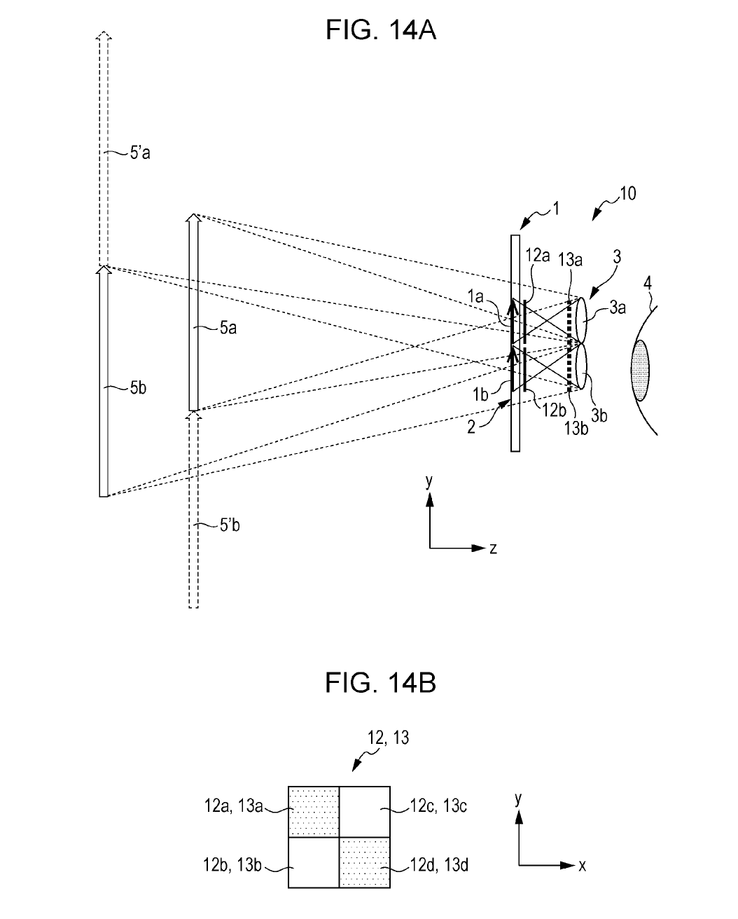

FIG. 14A is a diagram illustrating the image display device 10 according to a fourth embodiment. This image display device 10 includes the display member 1, a first polarizer array 12, a second polarizer array 13, and the lens array 3. The present embodiment differs from the third study case with regard to the point that the first polarizer array 12 and second polarizer array 13 are interposed between the display member 1 and the lens array 3. Other configurations are the same as the third study case, and accordingly redundant description will be omitted.

The first polarizer array 12 has multiple first linear polarizers, each of which are disposed correspondingly to one of the multiple divided regions 2a through 2d. The polarization directions of two adjacent first linear polarizers are generally orthogonal. The second polarizer array 13 is disposed between the first polarizer array 12 and the lens array 3. The second polarizer array 13 has multiple second linear polarizers, each of which are disposed correspondingly to one of the multiple divided regions 2a through 2d. The polarization directions of two adjacent second linear polarizers are generally orthogonal. At the same divided region, the polarization directions of the first linear polarizer and the second linear polarizer corresponding thereto are generally the same. Now, the term “generally orthogonal” is not restricted to strictly having a 90° angle, and includes cases where the angle therebetween is deviated within a range of ±15° from 90°. The term “generally the same” is not restricted to strictly being the same, and includes cases where the angle is deviated within a range of ±15°. The term “adjacent” means that the distance between centers is the closest.

FIG. 14B is a plan view illustrating a configuration example of the first polarizer array 12 and the second polarizer array 13. The first polarizer array 12 includes individual linear polarizers 12a, 12b, 12c, and 12d, disposed correspondingly to the divided regions 2a, 2b, 2c, and 2d, respectively. The linear polarizers 12a and 12d (or 12b and 12c) at diagonal positions are analyzers that transmit linearly polarized light of the same direction. The polarization direction of transmitted light is in an orthogonal relationship between the linear polarizers 12a and 12d and the linear polarizers 12b and 12c. The second polarizer array 13 includes individual linear polarizers 13a, 13b, 13c, and 13d, disposed correspondingly to the divided regions 2a, 2b, 2c, and 2d, respectively. The linear polarizers 13a and 13d (or 13b and 13c) at diagonal positions are analyzers that transmit linearly polarized light of the same direction as the linear polarizers 12a and 12d (or 12 and 12c).

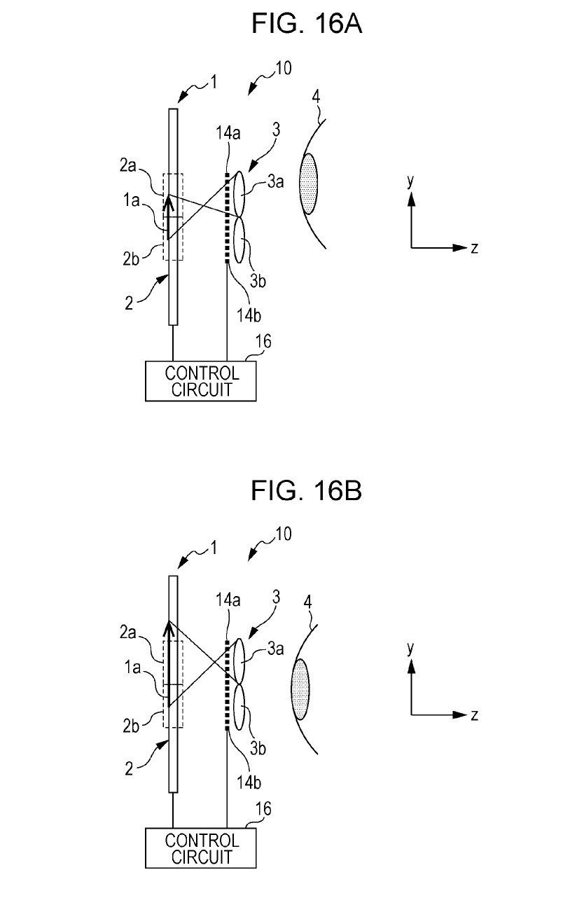

The light emitted from the divided regions 2a through 2d becomes linearly polarized light by passing through the corresponding linear polarizers 12a through 12d. The polarization directions of light passing through the two linear polarizers adjacent in the 45 degrees or 135 degrees direction as to the direction of array (x direction and y direction) match each other. On the other hand, the polarization directions of light passing through the two linear polarizers adjacent in the direction of array (x direction and y direction) are orthogonal to each other. Then these lights pass through the linear polarizers 13a through 13d, light entering from divided regions adjacent in the x direction and the y direction is shielded. Accordingly, unnecessary images from adjacent divided regions are not seen through the one lens as in the study case (images 5a′ and 5b′ in FIG. 16, for example). However, images of divided regions adjacent 45 degrees in the x direction or y direction can be seen, so suppression is not complete, but a certain level of effects is yielded.

While the present embodiment has been described assuming that non-polarized light is emitted from the divided regions 2a through 2d, there are cases where the display member 1 is a display that emits polarized light, such as in the case of a liquid crystal display. In this case, a half-wave plate may be disposed at every other position in the x direction and y direction, instead of the first polarizer array 12. Changing the polarization direction of the linearly polarized light by 90° using the half-wave plate can realize functions the same as those of the above-described first polarizer array 12. In this case, the direction of the polarization transmission axis of one type of the two types of linear polarizers is made to match the direction of the linearly polarized light passing through the half-wave plate, and the direction of the polarization transmission axis of the other type made orthogonal.

The configurations of the multiple divided region according to the present embodiment and the lens array 3 are not restricted to the configurations described in the third study case and the second embodiment. Other configurations, such as those of the first embodiment and so forth, may be optionally used.

### Fifth Embodiment

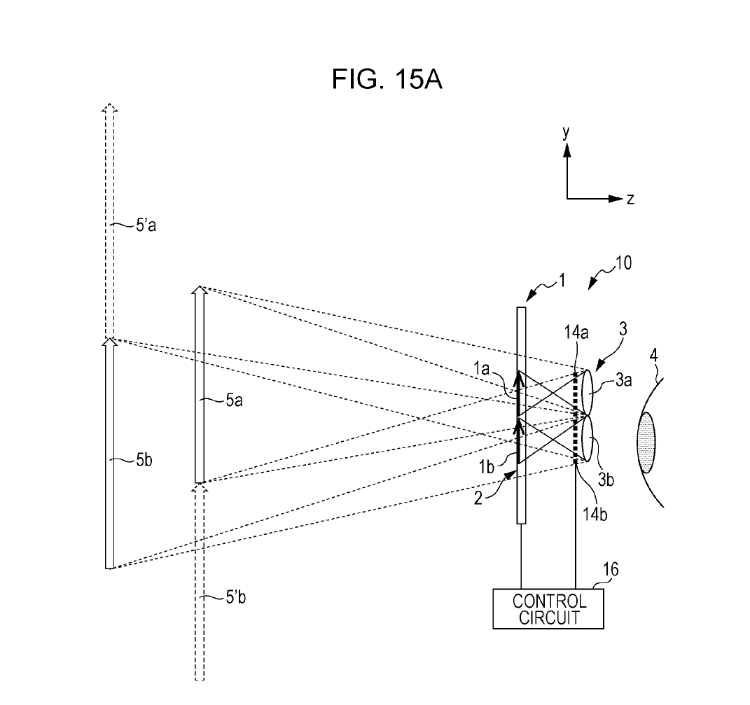

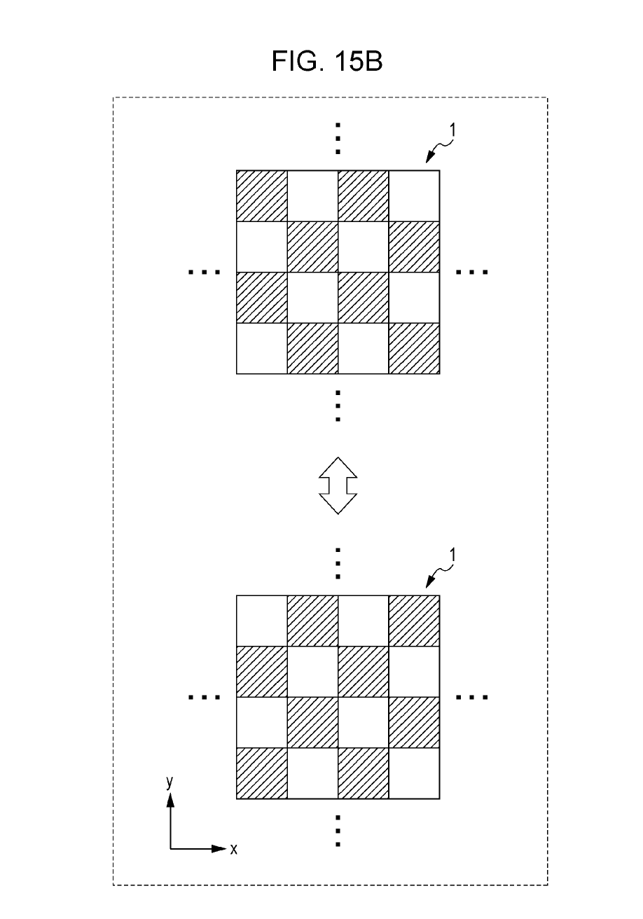

FIG. 15A is a diagram illustrating the image display device 10 according to a fifth embodiment. This image display device 10 includes the display member 1, multiple electronic shutters 14, the lens array 3, and the control circuit 16. The present embodiment differs from the third study case with regard to the point that the electronic shutters 14 are interposed, and that the control circuit 16 controls the display member 1 and the electronic shutters 14. Other configurations are the same as the third study case, and accordingly redundant description will be omitted.

The configuration of the multiple electronic shutters 14 is the same as the configuration illustrated in FIG. 8B. The multiple electronic shutters 14 include individual electronic shutters 14a, 14b, 14c, and 14d, disposed correspondingly to the divided regions 2a, 2b, 2c, and 2d. The electronic shutters 14a through 14d can independently switch transmission of light at each region on and off. Here, “on” means a state where the transmittance of light is relatively high (transmitting state), and “off” means a state where the transmittance of light is relatively low (shielded state).

The electronic shutter 14 has a structure where a thin layer formed sandwiched between transparent electrodes between a pair of linear polarizers is filled with liquid crystal. The polarization direction of the transmitted light is rotated by applying the pair of transparent electrodes applying voltage to the liquid crystal sandwiched therebetween, thus enabling the transmitted light to be switched on and off. The multiple electronic shutters can be configured by patterning and dividing one of the transparent electrodes, and individually controlling voltage. In a case where the display member 1 is a light-emitting member of linearly polarized light such as a liquid crystal display, the linear polarizers at the display member side may be omitted.

The control circuit 16 is electrically connected to the light-emitting elements and the multiple electronic shutters 14. The control circuit 16 can control the emission state of the multiple light-emitting elements and the transmission properties of the multiple electronic shutters 14. More specifically, synchronously with the timing to display an image at one of the multiple divided regions, the control circuit 16 places the one of the multiple electronic shutters 14 corresponding to that divided region in a transmitting state, while placing the other electronic shutters adjacent to that electronic shutter in a shielded state.

In the present embodiment as well, the configurations of the multiple divided regions and the lens array 3 are not restricted to the configurations described in the third study case and the second embodiment. Other configurations, such as those of the third embodiment and so forth, may be optionally used.

The placement of lenses and divided regions in the second embodiment has independent images displayed at each of the divided regions 2a through 2d. Accordingly, any single region can be lit and the other regions not lit. The placement of lenses and divided regions in the first and third embodiments enables any region to be lit by time division, and the other regions not lit. Synchronizing the on and off (emitting and non-emitting) of the divided regions 2a through 2d with the on and off (transmitting and shielding) of the corresponding individual electronic shutters 14a through 14d enables adjacent divided regions emitting at the same time to be prevented. Thus, images from adjacent divided regions are not visible through the lenses 3a through 3d. This solves the trouble with the study cases where adjacent unnecessary images (e.g., images 5a′ and 5b′ in FIG. 13) can be seen in the display image.

FIG. 15B is a diagram illustrating an example of control in the fifth embodiment. The display member 1 illustrated in FIG. 15B has a configuration where a great number of divided regions are two-dimensionally arrayed. Part of these divided regions may be the divided regions 2a through 2d in the embodiments described above. The white divided regions in FIG. 15B mean that the light-emitting elements (light source) are emitting light, and the grayed divided regions mean that the light-emitting elements are not emitting light. In this example, half of the divided regions, situated at every other position in the array directions (x direction and y direction) alone are caused to emit light during a certain period, and the light-emitting elements in the remaining divided regions are caused to emit light during another period. The on/off states of the corresponding electronic shutters are switched synchronously with the blinking of the divided regions. Repeatedly alternating these two light-emitting states enables light from adjacent divided regions to be suppressed from entering the lenses corresponding to the divided regions.

The light-emitting regions formed of the multiple light-emitting elements that display the individual images (1a, 1b, 1c, 1d, etc.) may extend beyond divided regions, and may straddle multiple divided regions. In other words, when displaying an image on one of the multiple divided regions, the control circuit 16 may also display that image extending into another adjacent divided region as well.

For example, as illustrated in FIG. 16A, a light-emitting region where an individual image is to be displayed may be shifted in a certain direction (the y direction in the illustrated example). In a state where the image 1a is being displayed in the example illustrated in FIG. 16A, the adjacent image 1b is not displayed, so the display of the image 1a may be extended from the divided region 2a to the divided region 2b side and displayed. In this case, the electronic shutter 14a is on and the electronic shutter 14b is off, so the image 1a appears to the user 4 in the direction shifted to the negative side of the y axis. Even if the image 1b is being displayed, the adjacent image 1a is not displayed, so the display of the image 1b can be extended from the divided region 2b to the divided region 2a side and displayed. At this time, the electronic shutter 14b is on and the electronic shutter 14a is off, so the image 1b appears to the user 4 in the direction shifted to the positive side of the y axis. Using this method enables the visual range of each image to be freely adjusted.

Also, an individual image may be displayed in a range larger than a single divided region, as illustrated in FIG. 16B. In this case as well, one image is displayed straddling multiple divided regions.

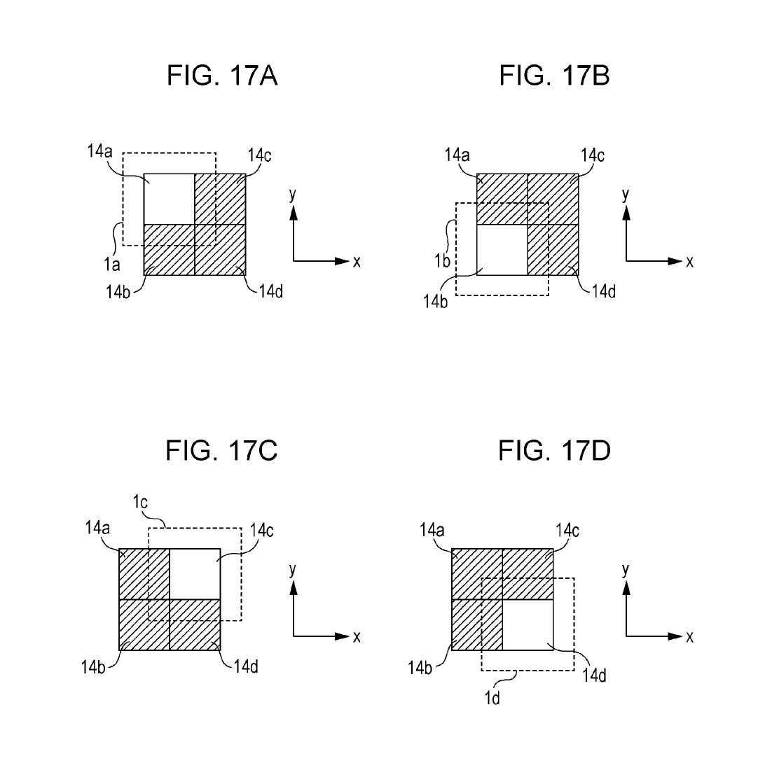

In a state where the image 1a is displayed as illustrated in FIGS. 16B and 17A, the surrounding images (1b, 1c, 1d, etc.) are not displayed, so the image 1a can be displayed extending from the divided region 2a into the surrounding divided regions. At this time, the electronic shutter 14a is on and the surrounding electronic shutters (14b, 14c, 14d, etc.) are off, so the image 1a appears to have a wide field angle when viewed from the user 4. In the same way, in a state where the image 1b is displayed as illustrated in FIG. 17B, the surrounding images (1c, 1d, 1a, etc.) are not displayed, so the image 1b can be displayed extending from the divided region 2b into the surrounding divided regions. At this time, the electronic shutter 14b is on and the surrounding electronic shutters (14c, 14d, 14a, etc.) are off, so the image 1b appears to have a wide field angle when viewed from the user 4. Also, in a state where the image 1c is displayed as illustrated in FIG. 17C, the surrounding images (1d, 1a, 1b, etc.) are not displayed, so the image 1c can be displayed extending from the divided region 2c into the surrounding divided regions. At this time, the electronic shutter 14c is on and the surrounding electronic shutters (14d, 14a, 14b, etc.) are off, so the image 1c appears to have a wide field angle when viewed from the user 4. Further, in a state where the image 1d is displayed as illustrated in FIG. 17D, the surrounding images (1a, 1b, 1c, etc.) are not displayed, so the image 1d can be displayed extending from the divided region 2d into the surrounding divided regions. At this time, the electronic shutter 14d is on and the surrounding electronic shutters (14a, 14b, 14c, etc.) are off, so the image 1d appears to have a wide field angle when viewed from the user 4. Using this method enables the field angle of each image to be freely enlarged and reduced.

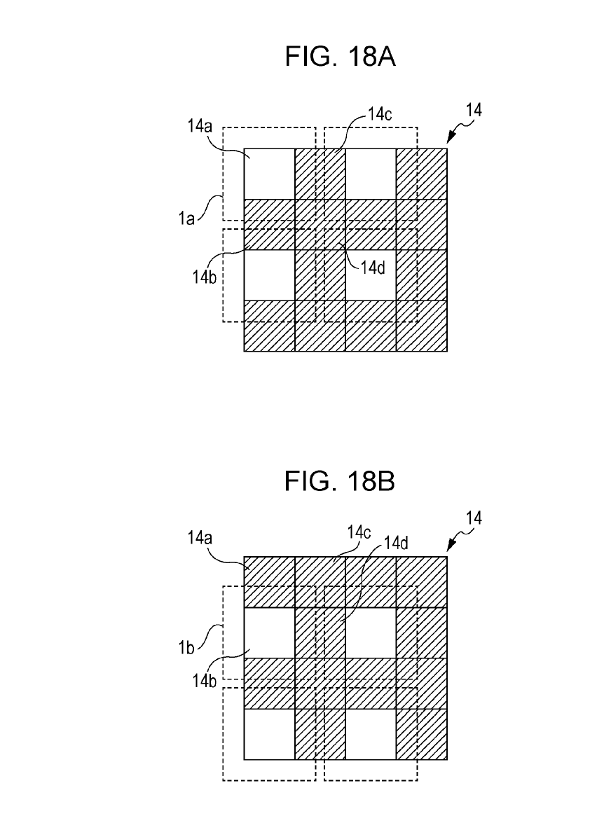

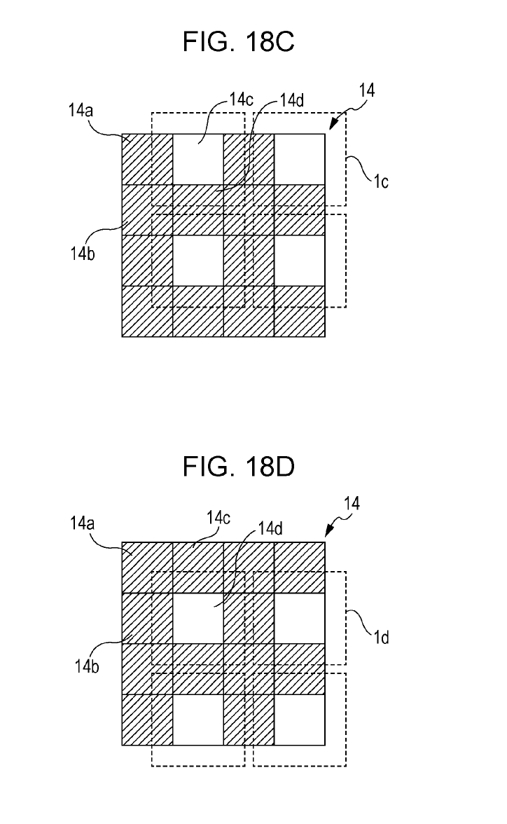

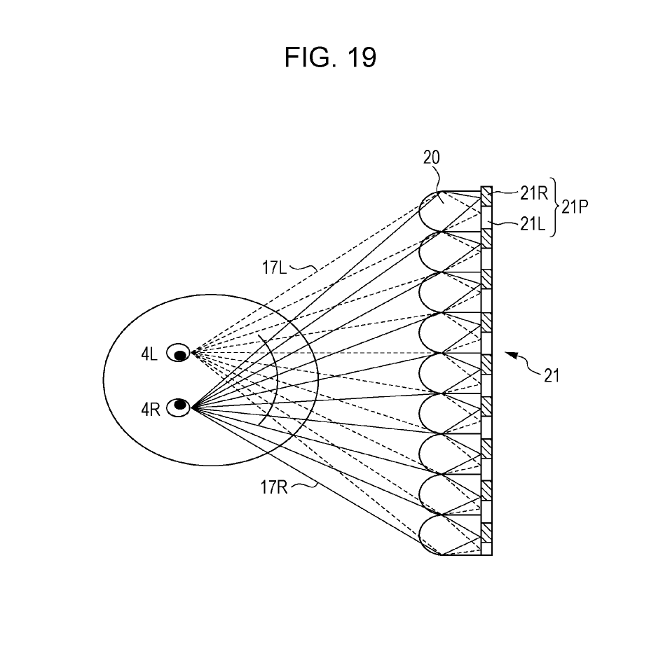

FIGS. 18A through 18D illustrate an example where the above-described light emission and electronic shutter control is extended to the surrounding divided regions. In this example, in a case where an image 1a is displayed centered on a divided region 14a as illustrated in FIG. 18A, the same (or different) image is displayed at every other divided region position in the x direction and the y direction from the divided region 14a. In the same way, in a case where an image 1b is displayed centered on a divided region 14b as illustrated in FIG. 18B, the same (or different) image is displayed at every other divided region position in the x direction and the y direction from the divided region 14b. In a case where an image 1c is displayed centered on a divided region 14c as illustrated in FIG. 18C, the same (or different) image is displayed at every other divided region position in the x direction and the y direction from the divided region 14c. In a case where an image 1d is displayed centered on a divided region 14d as illustrated in FIG. 18D, the same (or different) image is displayed at every other divided region position in the x direction and the y direction from the divided region 14d. Thus, the field angle of each image can be freely enlarged and reduced, and multiple images displayed on almost the entire screen of the display can be projected spatially with distances changed by time division, so substantial super-resolution (an image expression exceeding the number of pixels of the display) can be realized.

While description has been made in the above embodiments that the lenses included in the lens array 3 form virtual images from the images displayed at the corresponding divided regions, a design may be made where real images are formed. The lenses can form real images by the focal distance of the lens being shorter than the distance between the divided region and the lens. That is to say, the following Expression (8) can be used instead of Expression (4) when a lens corresponding to the divided region 2a is to form a real image, for example.

ba=fa×a/(a−fa) Expression (8)

This also holds true regarding the other divided regions 2b through 2d. When a lens forms a real image instead of a virtual image, the real image appears to be closer than the display face. Accordingly, this can be suitably applied to large-size displays in particular, where the distance between the display face and the lenses can be long. In applications where the distance between the display face and the lenses is relatively short, such as in head-mounted displays and the like, a typical design is for virtual images to be formed, but there may be cases including lenses that form real images.

What is claimed is:

1. An image display device comprising:
a display including light-emitting elements arrayed two-dimensionally, and having regions, in each of which a part of the light-emitting elements is located;
a lens array including lenses, each of the lenses being disposed correspondingly to one of the regions, the lens array forming real images or virtual images of images displayed at each of the regions; and
a control circuit that, in operation, controls each of the light-emitting elements, the control circuit being electrically connected to the display, and, in operation, causing a first part of the light-emitting elements to emit light when the control circuit causes a second part of the light-emitting elements different from the first part of the light-emitting elements not to emit light.

2. The image display device according to claim 1,
wherein the real images or virtual images of the images are formed to interpolate each other.

3. The image display device according to claim 1, wherein:
the first part of the light-emitting elements and the second part of the light-emitting elements are located next to each other.

4. The image display device according to claim 1,
wherein the first part of the light-emitting elements is located in one of the regions, and the second part of the light-emitting elements is located in another one of the regions.

5. The image display device according to claim 4, further comprising:
an electronic shutter array including electronic shutters disposed between the lens array and the display, each of the electronic shutters corresponding to one of the regions, wherein:
the control circuit is electrically connected to the electronic shutter array and, in operation, controls a light transmission property of each of the electronic shutters; and
synchronously with a timing of causing the first part of the light-emitting elements to emit light, the control circuit controls the light transmission property of a first part of the electronic shutters corresponding to the first part of the light-emitting elements to be a transmitting state, and controls the light transmission property of a second part of the electronic shutters corresponding to the second part of the light-emitting elements to be a shielding state.

6. The image display device according to claim 1, further comprising:
a beam splitter,
wherein the lens array is a mirror lens array that reflects light from the regions and forms the virtual images,
and wherein the beam splitter is disposed between the display and the mirror lens array, the beam splitter transmitting a part of the light in a direction of the mirror lens array.

7. An image display device comprising:
a display including light-emitting elements arrayed two-dimensionally, and having regions, in each of which a part of the light-emitting elements is located;
a lens array including lenses, each of the lenses being disposed correspondingly to one of the regions, the lens array forming real images or virtual images of images displayed at each of the regions;
an electronic shutter array including electronic shutters disposed between the lens array and the display, each of the electronic shutters disposed correspondingly to one of the regions; and
a control circuit that is electrically connected to the light-emitting elements and the electronic shutter array and, in operation, controls a light-emitting state of each of the light-emitting elements and a light transmission property of each of the electronic shutters,
wherein, synchronously with a timing of causing one of the images to be displayed at a first region of the regions by controlling the light-emitting state of the light-emitting elements, the control circuit controls a first electronic shutter of the electronic shutters that corresponds to the first region to be a transmitting state, and controls a second electronic shutter of the electronic shutters adjacent to the first electronic shutter to be a shielding state.

8. The image display device according to claim 7,
wherein, when displaying the one of the images at the first region, the control circuit displays the one of the images in a manner extending into a second region adjacent to the first region as well.

9. The image display device according to claim 7,
wherein an optical distance between each of the lenses and the corresponding one of the regions differs from a focal distance of each of the lenses.
